(19) United States
(12) Patent Application Publication
(10) Pub. No.: US 2025/0071863 A1
(43) Pub. Date: Feb. 27, 2025

(54) BATTERY-INTEGRATED APPLIANCE SYSTEM AND METHOD

(71) Applicant: Channing Street Copper Company, Berkeley, CA (US)

(72) Inventors: Samuel Calisch, Oakland, CA (US); Tucker Gilman, Oakland, CA (US); Dan Goldwater, Amherst, MA (US); Eric Wilhelm, Oakland, CA (US); David Kosecoff, San Francisco, CA (US); Pushan Chandra Panda, San Francisco, CA (US); Miles Smith, Cambridge, MA (US); Kaitlyn Thomas, Berkeley, CA (US); Mitchell Heinrich, Oakland, CA (US)

(21) Appl. No.: 18/814,022

(22) Filed: Aug. 23, 2024

Related U.S. Application Data
(60) Provisional application No. 63/534,727, filed on Aug. 25, 2023.

(51) Int. Cl. H05B 6/04; H02J 3/32; H02J 7/00; H05B 6/06; H05B 6/08; H05B 6/12

(52) U.S. Cl. CPC H05B 6/04; H02J 3/32; H02J 7/00034; H05B 6/062; H05B 6/08; H05B 6/12; H02J 2310/14

(57) ABSTRACT

A method of determining an operating configuration of a stove having: a cooktop having a plurality of heating regions; a power cord connected to a receptacle; a housing; a battery disposed within the housing, where the obtained stove use data comprises information regarding use of at least one of the heating regions of the cooktop. The method includes determining an operating configuration based at least in part on obtained stove use data and obtained power availability data, the determined operating configuration including one of: a full power configuration where the heating regions operate at a maximum power greater than 120V input voltage based on power from both the receptacle and the battery or power solely from the battery, and a reduced power configuration where the heating regions operate at a reduced power less than the maximum power, based on power solely from the receptacle or power solely from the battery.

### CROSS-REFERENCE TO RELATED APPLICATIONS

This application is a non-provisional of and claims the benefit of U.S. provisional patent application No. 63/534,727, filed Aug. 25, 2023, entitled “SYSTEMS AND METHODS FOR BATTERY ENHANCED APPLIANCES,” with attorney docket number 0122186-002PR0. This application is hereby incorporated herein by reference in its entirety and for all purposes.

This application is also related to U.S. patent application Ser. No. 17/692,714, filed Mar. 11, 2022, entitled “APPLIANCE LEVEL BATTERY-BASED ENERGY STORAGE,” which is a non-provisional of and claims the benefit of U.S. Provisional Application No. 63/159,851, filed Mar. 11, 2021, entitled “APPLIANCE LEVEL BATTERY-BASED ENERGY STORAGE,” which applications are hereby incorporated herein by reference in their entirety and for all purposes.

### GOVERNMENT LICENSE RIGHTS

This invention was made with government support under grant DE-FOA-0002196 awarded by the “BENEFIT 2020 program” of the Department of Energy's Building Technologies Office. The government has certain rights in the invention.

### BRIEF DESCRIPTION OF THE DRAWINGS

FIG. 1 illustrates an example of a powered building system of one embodiment.

FIG. 2 illustrates examples of load sources that can be associated with a powered building system of some embodiments.

FIG. 3 illustrates an example embodiment of a stove load source that comprises a load source system having a battery.

FIG. 4 illustrates one example embodiment of a load source system, which can comprise one or more batteries, a processor, a memory, a clock, a control system, a communication system, an interface, an electrical power bus, an AC/DC conversion module and one or more sensors.

FIG. 5 illustrates another example embodiment of a load source system that comprises an electrical input, a charger, an induction driver, a battery, a DC-DC converter, and inverter, a switch and an auxiliary electrical output.

FIG. 6 illustrates another embodiment of a load source system.

FIG. 7 illustrates a further embodiment of a load source system.

FIG. 8 illustrates a still further embodiment of a load source system.

FIG. 9 is a block diagram of an example method of determining an operating configuration for a load source system.

It should be noted that the figures are not drawn to scale and that elements of similar structures or functions are generally represented by like reference numerals for illustrative purposes throughout the figures. It also should be noted that the figures are only intended to facilitate the description of the preferred embodiments. The figures do not illustrate every aspect of the described embodiments and do not limit the scope of the present disclosure.

### DETAILED DESCRIPTION OF THE PREFERRED EMBODIMENTS

Systems and methods for battery enhanced appliances described in various embodiments discussed herein can function to provide various solutions and enhanced functionality for a modern appliance. In particular, the systems and methods of some examples can provide an energy storage equipped cooking stove (or other type of appliance) that uses an electrical architecture and configuration that ensures safety and provides DC power to high-load cooking elements of a stove or other type of electrical appliance.

The systems and methods of some embodiments may include components and/or operational processes to facilitate conversion from an alternating current power source (e.g., from a wall outlet) to DC power used to drive various elements of the stove (e.g., high-load elements such as convection and/or broiler heating elements of an oven, induction coil drivers, and/or integrated induction stovetop modules) and charge an auxiliary power source, which may also supply DC power. In some variations, the DC power matches voltage of the auxiliary power source (e.g., storage battery voltage) such that the high-load elements of an appliance may be powered directly from the auxiliary power source without further voltage conversion.

The systems and methods of various embodiments may include or be implemented through an AC power input, an AC/DC conversion module, and one or more heating modules/elements. The heating module/element may include an induction heating module (e.g., used for induction stovetop) and/or a resistive heating module/element (e.g., used for an oven, cooktop, clothes dryer, water heater, heat pump, or the like). The system may additionally include an auxiliary power source that can be managed and used as a backup or as a supplement to power delivered through the AC power input.

The components of various embodiments are integrated into an appliance system such as a cooking range, an oven, a cooktop, a clothes dryer, water heater, heat pump, or the like. Depending on the capabilities and features of such an appliance, the exact architecture of the appliance may be adjusted. For example, the system and methods discussed herein can be embodied in a stove or other appliance configured to be a combined stovetop and an oven, just a stovetop, just an oven, and/or any suitable type of cooking appliance.

The systems and methods are described in some examples in the context of use and application with an induction stove having a cooktop and oven, but these examples should not be construed as limiting. The systems and methods of various embodiments may additionally or alternatively comprise resistive heating in addition to or in place of induction heating. The systems and methods of various embodiments can be modified or configured for use with other electrical appliances or devices such as water heaters, laundry machines/dryers, heat pumps, and the like.

In some variations, a battery enhanced appliance may be used in connection with a network of other appliances. These can be other appliances in the same house, which may also be battery enhanced appliances or may be other types of electrical appliances without battery or power storage. In some variations, the systems and methods of some examples may be used with a powered building system and electric power distribution system such as the one described in U.S. patent application Ser. No. 17/692,714, filed Mar. 11, 2022, entitled “APPLIANCE LEVEL BATTERY-BASED ENERGY STORAGE,” which is incorporated by reference.

As one potential benefit, the systems and methods of some examples can enable use of a line power source (i.e., a wall outlet power source) with a battery power source to augment capabilities of an electric stove. The systems and methods of some examples can preserve functionality and capabilities of more traditional natural gas ranges while enabling a transition to electrical power. Enabling use of an electrical power source can have many benefits as the world transitions to more sustainable power sources.

As one potential benefit, the system and method of some examples may lower the requirements of a building's existing electrical system when using an electrical appliance, thereby enabling wider adoption of electrical appliances. Common residential electrical outlets (e.g., “120V standard outlet”) can have insufficient power capacity for many appliances, typically requiring installation of a higher voltage and higher power outlet (e.g., “240V appliance outlet”). By augmenting an appliance with the systems and methods of some embodiments (e.g., an integral or attached energy storage system such as a battery), a standard 120V electrical outlet may be used with the systems and methods of various examples to supply a much higher power level to the appliance in a non-continuous-use application. In some embodiments, this can be an equivalent power level to a traditional 240V appliance outlet.

In some variations, such as an on-demand hot water heater, even a single 240V appliance outlet can be insufficient for the appliance, and by using some embodiments herein, sufficient power can be provided to the appliance in various examples, which might otherwise require a multi-circuit and/or hard-wired electrical installation, or might exceed the capacity of the entire load center.

As another potential benefit, the systems and methods of some embodiments may enable use of the stove and/or other appliance type during varying power availability. For example, some variations described herein may allow for use of the stove during power blackouts, during increased grid use (e.g., when electrical costs are high), and/or when using other electrical appliances at the same time.

As another potential benefit, systems and methods of various embodiments can avoid limitations and problems that occur with AC induction-based heating appliances. This may include audible and tactile vibrations that can make the cooking experience less pleasurable. Furthermore, some variations of the systems and methods discussed herein may enable customization of the sound and feel of induction cooking to make the cooking experience more pleasurable and/or safe. For example, some auditory and/or vibrational sensations may be actively enabled when cooking as a form of feedback that a pot is heating up. These auditory and tactile cues could be varied based on conditions.

As another potential benefit, the systems and methods of some examples may enable a reduction in usage of various components used in AC appliances. For example, the systems and methods of various embodiments may avoid or reduce the number of filter capacitors/inductors, rectification systems. In particular, the systems and methods of some examples may eliminate or reduce the need for a PFC circuit and/or EMI/RFI circuits, which may be required for an AC-powered induction device. The firmware may similarly be simplified in some embodiments. The resulting systems and methods of various embodiments may enable an appliance that can be less heavy, smaller, cheaper and quieter.

As another potential benefit, the systems and methods of some embodiments can decouple device performance from limitations of outlet capacity and/or inverter capacity. The systems and methods of various examples comprise a battery that can enable capacity and power capabilities to be based on the battery. A stove in some embodiments can be designed with power capacity to support increased number of cooktop heating zones, larger cooktop heating zones, more ovens, larger ovens, faster preheat times, more fans, more lights, and/or other features.

In one example, a system variation can include a battery charger that can draw up to 15 A from a standard 120V wall outlet, charging the battery with a nominal 230 VDC and 5 kWh capacity. Once fully charged, the system in various embodiments can supply, for example, approximately 7 kW for one hour to an appliance (5 kW from the battery+1.875 kW from the standard wall outlet), after which the battery may need re-charging. In a scenario of some examples, the battery charges whenever the appliance is not in use, or in use at a low power level, such that it is fully charged when needed or desired. The specific battery voltage can be adjusted in various embodiments based on the internal design of the appliance load elements. The battery capacity (kWh) can be adjusted in various embodiments based on a desired usage profile of the appliance, cost, or other factors. In another example, the charger may draw 30 A from a standard 240V appliance outlet, charging a battery with a nominal 230 VDC and 10 kWh capacity. Once fully charged, the system of some embodiments can provide approximately 30 kW for 20 minutes, as might be utilized in some examples by an on-demand hot water heater which may require 2× or 3× the capacity of a standard 240V appliance outlet.

One example embodiment includes a first battery system that is an integral component of and disposed within a housing of a first load source of the plurality of load sources, the first load source comprising a first power cord plugged into a first receptable of the plurality of receptacles, the first battery system comprising a first battery configured to obtain and store power from the first receptacle, the first load source being configured to be fully powered by power stored by the first battery and configured to be fully powered by power obtained from the first receptacle and configured to be partially powered by both the first battery and power obtained from the first receptacle.

Various embodiments can eliminate significant upgrade costs required to replace fossil fuel appliances. Many electric appliances (e.g., induction ranges and electric dryers) require dedicated high-capacity circuits to be installed, but only draw their full capacity for short periods of time. This electrical work can significantly increase the cost of such an upgrade, providing a large barrier to entry, and can negate any value proposition the increased efficiency of these more advanced appliances may provide. As an example, a four-burner induction cooktop with oven on its own runs from $1,000-$2,000, and (in the lucky case where an appropriate 240V circuit is already available) can be installed by the homeowner or a general contractor for $150-$200. If a stove of some embodiments is replacing a natural gas stove, however, the likelihood that an appropriate, unused circuit is available at the correct location is very low, and the cost to install the required 30-40 amp appliance circuit is roughly $800-1,000, with an additional $380-$460 required if the routing from the circuit breaker to the stove is long or inconvenient. Further, in most cases the available electrical service was designed assuming fossil fuel use and is insufficient for this large additional circuit. Upgrading the service panel in this situation can add an additional $1,500-$4,000 on top of the project cost, making the total cost of replacing the natural gas stove a factor of 2-6 higher than the underlying new appliance cost.

In various embodiments, appliances with integrated or associated batteries as discussed herein can eliminate the need to upgrade electrical service, as they can supply the required high current during use, while only drawing meager average power from an existing 110V electrical outlet to recharge. In the case of the induction stove, the overwhelming majority of dinnertime cooking needs can be met by a 0.75-1.5 kWh integrated battery. This battery can add a mere $100-$200 to the appliance cost if installed in the factory at current EV prices, and less as the scale of this industry continues to bring costs down. As a result, the total project cost to the homeowner to eliminate this source of residential emissions remains predictable and low, and the dinnertime cooking loads, which occur largely outside the productive window for solar, can be cost-effectively shifted to be powered by renewables.

Additionally, centralized main home batteries can require large, dedicated inverters to supply AC power, even when appliances (e.g., induction stoves) use internal rectification to convert the power back to DC. Placing batteries at these points of load can allow direct DC powering of the appliance, with only modest AC draw from the electrical outlet in various embodiments. On a systemic level, in various embodiments this can eliminate the inversion-rectification cycle on power drawn and deferred from the grid, and significantly reduce the power requirements on an inverter supplying power from a rooftop solar array. The result can be a reduction in system cost, and an efficiency increase due to eliminated power conversions.

Also, large battery packs that may be required for main home batteries are often spoiled by a single bad cell. In contrast, a ˜1 kWh commoditized pack that can be used to power a home appliance can be easier to manage than centralized batteries, and in various embodiments can be made easier to replace in the event of failure. Having fewer cells under a battery management system (BMS) can allow, in some embodiments, better control over charge cycle, mechanical, and thermal stress and more robust health diagnostics, leading to longer battery life. Battery management systems and supporting power electronics can be at a price point such that an increased number of them does not present a cost barrier. As an additional benefit to this approach, in some embodiments smaller battery packs used for point of load storage can be more appropriate for second-life applications of plug-in EV batteries—supply of which is expected to grow rapidly in the next 10 years. Even after use in an EV, such cells are expected to have 70% of their initial capacity and be viable for another 10 years in their second-life application.

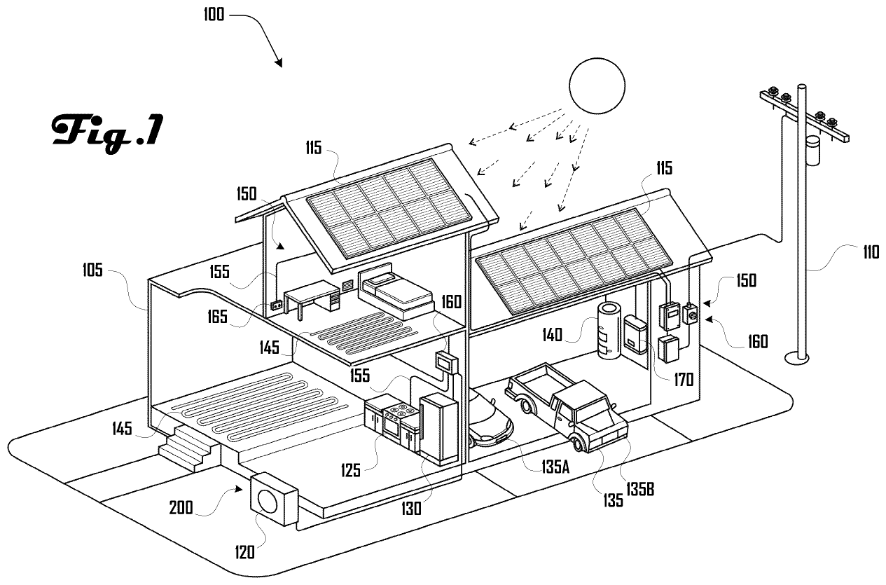

FIG. 1 illustrates an example of a powered building system 100 that comprises a building 105, which can obtain electrical power from various suitable sources such as an electrical power grid 110, one or more solar panels 115, and the like. Such electrical power can power to various suitable load sources 200 (e.g., appliances, elements, systems, vehicles, and the like), such as a heat pump 120, electric stove 125, refrigerator 130, electric vehicles 135, water heater 140, electrical floor heating elements 145, and the like. Power can be distributed to or among such load sources 200 via an electric power distribution system 150 that can comprise power lines 155, electrical sub-elements 160 that provide power to electrical receptacles 165, or the like.

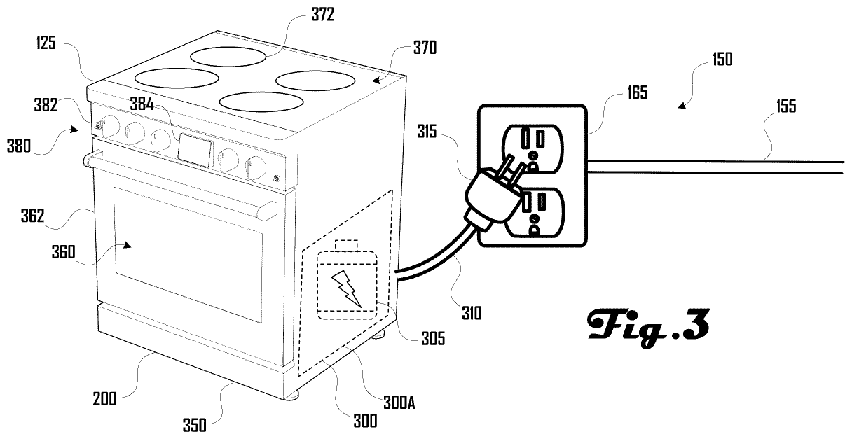

As discussed in more detail herein, in various embodiments load sources 200 can be respectively associated with a battery 305 and/or load source system 300 (See e.g., FIG. 3); however, in some embodiments, the powered building system 100 can comprise one or more building system battery 170 that is not directly associated with a specific load sources 200, and can be configured to store energy for the powered building system 100 generally for distribution to the electrical power grid 110, to the load sources 200 associated with the powered building system 100, or the like. In some embodiments a building system battery 170 can be absent.

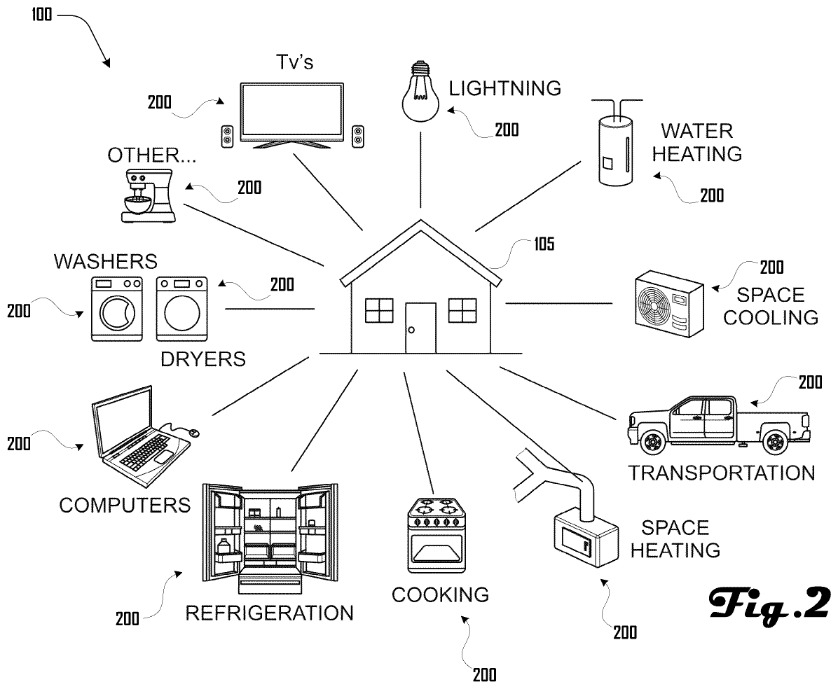

While FIG. 1 illustrates one example embodiment of a powered building system 100, such an embodiment should not be construed to be limiting on the wide variety of load sources 200 that can be powered, associated with a battery and/or battery system, or the like. For example, FIG. 2 illustrates further examples of load sources 200 that can be associated with the powered building system 100 in further embodiments. Additionally, while various embodiments of a powered building system 100 can relate to a single-family residential home, it should be clear that further embodiments can relate to multi-family residences, mixed-use buildings, commercial buildings, factories, airports, farms, or other suitable building, structure, or land. Additionally, some embodiments can be applicable to vehicles or structures such as a cruise ship, offshore platform, airplane, bus, or the like.

Also, while the example of FIG. 1 illustrates a powered building system 100 associated with an electrical power grid 110, such as regional electrical power provider that provides power to a plurality of buildings 105 and/or powered building systems 100, in further embodiments a powered building system 100 may not be associated with or connected to an electrical power grid 110. Additionally, while the example of FIG. 1 illustrates a powered building system 100 that obtains electrical power from one or more solar panels, in further embodiments any suitable additional or alternative electrical power generation systems and methods can be part of a powered building system 100, such as a wind turbine, water turbine, geothermal power generator, nuclear power system, chemical or combustion power generator, or the like.

FIG. 3 illustrates an example of a stove 125 load source 200 that comprises an embodiment 300A of a load source system 300 having a battery 305. For example, the load source system 300A can be an internal component of the stove 125, an integral component of the stove 125, disposed within a housing of the stove 125, or the like. For example, in some embodiments, a portion of the load source system 300A and/or battery 305 can be an integral part of the stove 125 such that such portions cannot be removed or easily removed from the stove 125, which can include, in some examples, such portions being enclosed within a housing of the stove 125 so that such portions are not accessible externally to users. However, in some examples, the battery 305 can be removable, replaceable, and/or modular as discussed herein.

As shown in FIG. 3, the stove 125 can comprise a power cord 310 with a plug 315 configured to couple with an electrical power receptacle 165 of a power distribution system 150. For example, the power distribution system 150 can provide power to the receptacle 165 via power lines 155, where the receptacle 165 is disposed on a wall of a building 105 (FIG. 1) with power lines 155 running though the wall, or the like. The stove 125 can plug into the receptacle 165 which can provide electrical power to the stove 125 and the battery 305 of the load source system 300, which can be configured to store electrical power and/or provide electrical power to the stove 125 as discussed herein.

In various embodiments, the stove 125 can comprise a housing 350, an oven 360 having an oven door 362, a cooktop 370 having one or more heating regions 372 and a stove interface 380 having a plurality of knobs 382 and display 384. As discussed herein in more detail such elements can be a part of or associated with the load source system 300, such as heating elements of a load source system 300 being configured to generate heat in the oven 360 and/or at the cooktop 370 based at least in part on configuration of the knobs 382 and/or display 384 of the stove interface 380. In various embodiments, the stove 125 can be an inductive stove that includes an induction driver that powers induction coils associated with one or more heating regions 372. However, the oven 360 and/or heating regions 372 of the cooktop 370 can be heated or generate heat in any suitable way in further embodiments, including inductive heating, resistive heating, gas heating, halogen heating, microwave heating, convection heating, radiant heating, steam heating, solid fuel heating, and the like.

One preferred embodiment includes a stove 125 that is standard 30-inch range having a width of 29⅞ inches; depth of 28 15/16 inches, including handle; and height of 35¾ to 36¼ inches to the cooking surface. Further embodiments of a stove can have a standardized or customized width of, or be configured for a width of, 20, 22, 24, 26, 28, 30, 32, 34, 36, 38, 40, 42, 44, 46, 28 inches, and the like, or a range between such example values. In some embodiments, a stove 125 can have depth of 25, 26, 27, 28, 29, 30 inches, or the like, or a range between such example values. In various embodiments, a stove 125 can be configured for a standard 36-inch countertop height with adjustable legs that provide adjustment of +/−0.25, 0.5, 0.75, 1.0 inches, or the like, or a range between such example values.

In one preferred embodiment, a stove 125 has an oven 360 with an oven capacity of 4.55 cubic feet, and oven width of 22⅛ inches, an oven depth of 16¼ inches, an oven height of 17 inches and five oven rack positions. Further embodiments can include an oven 360 with a capacity of 2.0, 2.5, 3.0, 3.5, 4.0, 4.5, 5.5, 6.0, 6.5 cubic feet, or the like, or a range between such example values.

In one preferred embodiment, a cooktop 370 of a stove 125 comprises four symmetrical 7.9-inch high-power induction cooking zones 372 that have a minimum pan pairing size of 3⅛ inches. In further embodiments, a stove 125 can comprise any suitable number of cooking zones 372, including 1, 2, 3, 4, 5, 6, 8, 10, 12, or the like, or a range between such example values. Such cooking zones 372 can be the same size or different sizes and can include a diameter of 5, 6, 7, 8, 9, 10, 11, 12 inches, or the like, or a range between such example values. Such cooking zones 372 can be planar or in some embodiments can be concave to accommodate a curved pan (e.g., for induction cooking). However, it should be clear that further embodiments can include any suitable stove, range, or the like, which can include any suitable elements in various suitable configurations, so the present examples should not be construed as being limiting.

In some embodiments, one or more batteries 305 and/or battery systems 300 can be integrated into a load source 200 (e.g., into an appliance housing) at the factory where the load source is manufactured or can be integrated into load source aftermarket. For example, load sources 200 (e.g., appliances) can be specifically designed to allow integration of the appropriate quantity of batteries 305 and/or other elements of a load source system 300 within their normal housing. This can allow for such load sources 200 or appliances to be placed within a residence without any change to how they are integrated into standardized fixturing, such as counters. In various embodiments, electrical connections to batteries 305 and/or other elements of a load source system 300 are made in the factory and fully integrated into the appliance circuit. This can allow for load sources 200 such as appliances that utilize DC current (e.g., induction stove) to pull power directly from the one or more batteries 305 without the added cost of a high-power inverter.

In some embodiments, batteries can be designed to be integrated into load sources (e.g., appliances) in an aftermarket factory setting. For example, a company that is not the original equipment manufacturer of an appliance buys new appliances, installs the load source system 300 in their own facility, and re-sells the appliance as new. The retrofitter in some examples installs one or more batteries 305 and/or elements of the load source system 300 within the housing of the appliance, wiring them directly into the integral electrical system of the appliance. This can be desirable in some embodiments if high-voltage connections are required given the danger of such high-voltage connection if not being handled by a professional. Also, in some embodiments where a load source 200 (e.g., an appliance) has an internal rectification circuit, such as an induction stove or the like, that is converting 60 Hz AC current to DC, it can be desirable in some examples to connect the load source system 300 directly into the internal circuitry of the load source (e.g., to avoid costly addition of high-power inversion).

In some embodiments, batteries 305 and elements of a load source system 300 are designed to nest with load sources (e.g., appliances), either as a footing, or a backing, etc. Such nesting can be done by the customer in various examples. Batteries 305 and/or elements of a load source system 300 can be designed to nest directly external to the appliance, such as by taking into consideration the shape and intended location of the appliance within a house 105. One or more batteries 305 and elements of a load source system 300 (e.g., power control stage) are packaged in such a way in various examples such that they can be placed directly alongside the appliance. The appliance can be plugged into the load source system 300 and the load source system 300 is then plugged into the wall.

Additionally, it should be clear that a powered building system 100 can include any suitable number and type of battery systems 300 including one or more of the battery systems 300 shown herein. However, in some examples one or more of the battery systems 300 shown herein can be specifically absent.

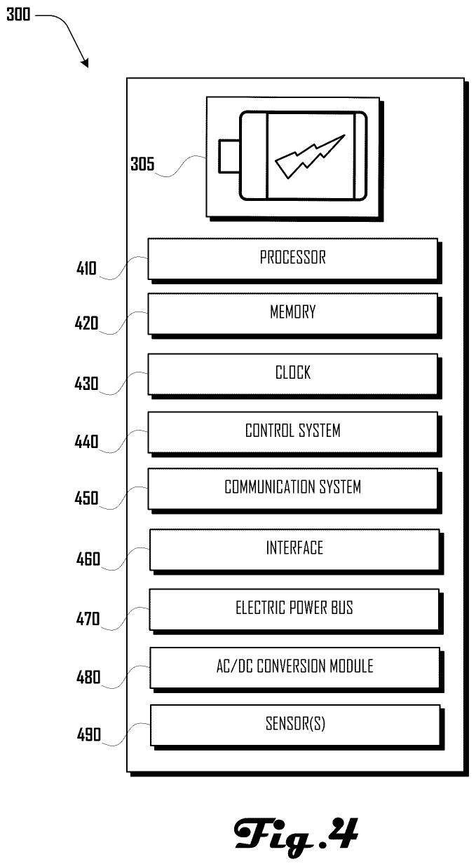

A load source system 300 can comprise various suitable elements. For example, FIG. 4 illustrates one example embodiment of a load source system 300, which can comprise one or more batteries 305, a processor 410, a memory 420, a clock 430, a control system 440, a communication system 450, an interface 460, an electrical power bus 470, an AC/DC conversion module 480 and one or more sensors 490.

For example, in some embodiments, a load source system 300 can comprise a computing device which can be configured to perform methods or portions thereof discussed herein. The memory 420 can comprise a computer-readable medium that stores instructions, that when executed by the processor 410, causes the load source system 300 to perform methods or portions thereof discussed herein, or other suitable functions. The clock 430 can be configured to determine date and/or time (e.g., year, month, day of the week, day of the year, time, and the like) which as discussed in more detail herein, can in some examples be used to configure the power storage and/or power discharge of the battery 305 based on time.

The control system 440 in various embodiments can be configured to control power storage and/or power discharge of the battery 305 based on instructions from the processor, or the like. Additionally, in some embodiments, the control system 440 can determine various aspects, characteristics or states of the battery 305 such as a charge state (e.g., percent charged or discharged), battery charge capacity, battery health, battery temperature, or the like. For example, in various embodiments, a load source system 300 can comprise various suitable sensors to determine such aspects, characteristics or states of the battery 305 or aspects, characteristics or states of other elements of a building system 100 which can include environmental conditions such as temperature, humidity, or the like, internal to or external to a building 105.

In some embodiments, the control system 440 can be configured for various features such as: maintaining a data pipeline to the cloud or another wireless device (e.g., by way of CANBus communication between peripherals and a Wi-Fi, Bluetooth, or Cellular module) to remotely log system data and manage firmware updates; interpreting the states/positions of user interface controls (e.g., knobs, buttons, switches) and carrying out corresponding actions within the device; providing feedback control to cooking operations of the load source system 300 via temperature and current sensing; and the like. The control system 440 may additionally be used in enabling and facilitating various operating modes and features (e.g., cooking features, safety features, etc.)

In various embodiments, the communication system 450 can be configured to allow the load source system 300 to communicate via one or more communication networks as discussed in more detail herein, which in some embodiments can include wireless and/or wired networks and can include communication with devices such as one or more other battery systems 300, user device, server, or the like.

The interface 460 can include various elements configured to receive input and/or present information (e.g., to a user). For example, in some embodiments, the interface can comprise a touch screen, a keyboard, one or more buttons, one or more knobs, one or more lights, a speaker, a microphone, a haptic interface, and the like. In various embodiments, the interface 460 can be used by a user for various suitable purposes, such as to configure the load source system 300, view an aspect, characteristic or state of the load source system 300, configure network connections of the load source system 300, or the like. In some embodiments, the interface 460 can comprise a stove interface 380 having a plurality of knobs 382 as shown in the example of FIG. 3.

The electrical power bus 470 can be configured to obtain electrical power from one or more sources and/or provide electrical power to one or more load sources 200. For example, in various embodiments, the electrical power bus 470 can obtain power from one or more power receptacles 165 (see, e.g., FIG. 3) or other suitable interface with a power distribution system 150, or directly from a power source such as an electrical power grid 110, solar panel 115, or the like. Such obtained electrical power can be stored via one or more batteries 305 or can be directed to one or more load sources 200 connected to the load source system 300. Such obtained electrical power can be directed to such one or more load sources 200 via the one or more batteries 305 or bypassing the one or more batteries 305.

In various embodiments, the AC/DC conversion module 480 (e.g., in an induction stove) can be configured transforming the alternating current (AC) such as from a standard household outlet into direct current (DC) suitable for powering various elements of the load source system 300 (e.g., parts of an induction stove). The AC/DC conversion module 480 of various examples can include a rectifier circuit, which converts the AC voltage into a pulsating DC voltage, followed by a filter that smooths out the fluctuations to produce a steady DC output. Additionally, the AC/DC conversion module 480 of various embodiments can include voltage regulation circuitry to ensure the output remains within a specific voltage range, accommodating the precise needs of the elements of the load source system 300 such as electronic controls and induction driver. The AC/DC conversion module 480 of some examples not only powers the main induction heating elements but also supplies DC power to auxiliary components such as a control panel, sensors, a cooling fan, and the like. Example embodiments of an AC/DC conversion module 480 and components thereof are discussed in more detail herein.

Any suitable sensors 490 can be used in a load source system 300. For example, various suitable sensors can be used for sensing temperature (e.g., for generating an over-temperature cut-off response) can including thermal fuses, thermostats, thermocouples, thermistors, PTC (Positive Temperature Coefficient) devices, RTDs (Resistance Temperature Detectors), bimetallic switches, IC temperature sensors, thermal cut-out switches, infrared sensors, and the like.

In further embodiments, sensors can include one or more of magnetic field sensors, like Hall effect sensors, to detect the presence and size of cookware; current and voltage sensors to monitor power consumption and protect against fluctuations; capacitive touch sensors for a user interface; safety features that can be supported by overheating protection and boil-dry detection sensors; pan detection sensors to identify when cookware is placed on or removed from cooking zones; power monitoring sensors to manage power distribution; residual heat sensors to indicate when a cooktop 370 is still hot after use; electromagnetic interference sensors to monitor and minimize emissions; humidity sensors to detect steam and adjust cooking parameters; weight sensors for more precise cooking; and the like.

The one or more batteries 305 can be any suitable system configured to store and discharge energy. For example, in some embodiments, the one or more batteries 305 can comprise rechargeable lead-acid, nickel-cadmium (NiCd), nickel-metal hydride (NiMH), lithium-ion (Li-ion), LiFePO₄ (Lithium Iron Phosphate), lithium-ion polymer (LiPo), rechargeable alkaline batteries, Sodium-ion (Na-ion), Lithium Titanate (LTO), Lithium Sulfur (Li—S), Nickel-Zinc (Ni—Zn), Zinc-Air, Solid-state lithium, Flow batteries (e.g., Vanadium Redox Flow Batteries), or the like.

In some embodiments, a battery 305 of a load source system 300 can be configured to generate various suitable voltages, including 80V, 90V, 100V, 110V, 120V, 130V, 140V, 150V, 160V, 170V, 180V, 190V, 200V, 210V, 220V, 230V, 240V, 250V, 260V, and the like, or a range between such example values. A battery 305 in various examples can comprise a plurality of cells, which in some examples can have a nominal voltage 3.0V, 3.1V, 3.2V, 3.3V, 3.4V, 3.5V. In one example, a battery 305 can comprise 72 cells in series, which can generate a voltage of ˜240 VDC (e.g., between 230 VDC and 250 VDC).

In various embodiments, components of the load source system 300, such as heating regions 372 of the cooktop 370, oven 360, auxiliary electrical output 540, and the like can be configured to operate at different input voltages such as 120V, 130V, 140V, 150V, 160V, 170V, 180V, 190V, 200V, 210V, 220V, 230V, 240V, 250V, 260V, and the like, or a range between such example values. For example, such an input voltage can be based on power from one or both of a receptacle 165 (e.g., 120V receptacle) and battery 305.

As discussed herein, rechargeable in various embodiments can be defined as having the ability to store and discharge energy multiple times without substantial degradation of the ability to store and discharge energy for at least a plurality of cycles (e.g., 5, 10, 50, 100, 500, 1000, 10k, 100k, 1M, 10M, 100M, or the like). While various preferred embodiments can include chemical storage of electrical energy, in further embodiments one or more batteries 305 can be configured to store energy in various suitable ways, such as mechanical energy, compressed fluid, thermal energy, and the like.

In some embodiments, the one or more batteries 305 can contain or be defined by removable cartridges that allow the one or more batteries 305 to scale or be replaced. Battery packs in some examples can be composed of small sub-packs that can be easily removed. This can allow for old or faulty cells to be replaced in some examples. Additionally, in some examples such a configuration allows for the fine tuning of pack size within a network of load source systems 300 as discussed herein. For example, one or more batteries 305 can be initially sized and colocated with an expected load source 200.

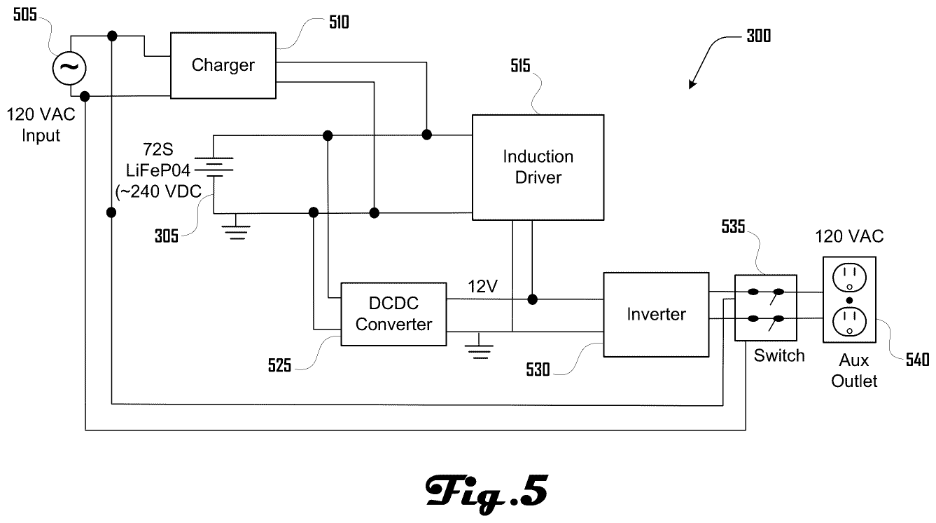

Turning to FIG. 5, another example embodiment of a load source system 300 is illustrated, which comprises an electrical input 505, a charger 510, an induction driver 515, a battery 305, a DC-DC converter 525, and inverter 530, a switch 535 and an auxiliary electrical output 540.

In various embodiments, the electrical input 505 can comprise a power cord 310 with a plug 315 configured to couple with an electrical power receptacle 165 of a power distribution system 150 (see, e.g., FIG. 3); however, various suitable elements can be part of an electrical input 505 and such an electrical input 505 can be via a direct-wire connection in various examples as discussed herein. In various embodiments, the electrical input 505 can be an AC power input that functions to provide a main source of power that can be used to charge and/or power elements of the load source system 300. The electrical input 505 may be used to power and charge an auxiliary power source or other power storage systems such as the battery 305 and/or power other elements such as a processor 410, memory 420, clock 430, control system 440, communication system 450, interface 460 (see, e.g., FIG. 4), or the like. In some examples, an AC power input of the electrical input 505 may be a 120 VAC (and/or 240 VAC) from a wall outlet (e.g., standard 15 A outlet).

In various embodiments, the charger 510 can comprise a power converter or a battery charger that manages a flow of electrical energy from the electrical input 505 to the battery 350 and/or induction diver 515. For example, in some embodiments, the charger 510 can convert an AC voltage (e.g., 120 VAC or 240 VAC) from a wall outlet into a suitable DC voltage required to charge the battery 305, which can involve rectification (converting AC to DC) and regulation (ensuring the DC output is stable and suitable for the battery). In some examples, an AC/DC regulator in an AC/DC conversion module of the charger 510 may be used to transform the power input from the electrical input 505. The charger 510 in various embodiments can monitor and control the charging process of the battery 305 to ensure it is charged efficiently and safely, preventing overcharging or overheating, and can manage the charging current and voltage according to the specifications of the battery 305.

In various embodiments, the charger 510 and/or battery 305 can supply DC power to the induction driver 515 to drive one or more induction coils to generate an electromagnetic field for heating. For example, in various embodiments, the induction driver 515 can be configured to be powered only by the charger 510; powered only by the battery 305; and/or powered by both the charger 510 and the battery 305 at the same time. As discussed herein, such powering capabilities can be desirable in various examples to allow for cooking via power from the battery 305 while power from the electrical input 505 is unavailable or undesirable such as when there is a power outage or when power obtained from the electrical input 505 is undesirably expensive (e.g., when such power obtained from a power grid is expensive). Such powering capabilities can be desirable in various examples to allow for a combination of power from the electrical input 505 and battery 305 to be used, which can allow for greater power to the induction driver 515 than would be available from the electrical input 505 alone, which can allow a stove 125 to perform near, at, or above the capability of a stove 125 powered by 240 VAC, even though the stove 125 is powered by only 120 VAC via the electrical input 505. Such powering capabilities can be desirable in various examples to allow for a combination of power from the electrical input 505 and battery 305 to be used, which can allow for a reduced amount of power consumed from the electrical input 505, which may be desirable when power obtained from the electrical input 505 is unstable, inconsistent, or undesirably expensive (e.g., when such power obtained from a power grid is expensive) or when it is desirable to draw less power from the electrical input 505 (e.g., where a circuit does not support drawing full power because of other appliances on the circuit). Such powering capabilities can be desirable in various examples to allow for the induction driver 515 to be powered via the electrical input 505, when it is undesirable to use power from the battery 305, when the battery 305 is out of power, when the battery 305 is malfunctioning, when the battery 305 is overheating, when power from the electrical input 505 is obtained from a renewable source (e.g., solar), or the like. As discussed herein, various additional and/or alternative elements can be powered via DC power from the charger 510 and/or battery 305, so the example of an induction driver 515 should not be construed to be limiting.

For example, the load source system 300 may additionally or alternatively power resistive, bake, convection and/or broiler heating elements of an oven. Further elements can include convection fans, cooling fans, oven lamps, status indicators (e.g., LEDs, displays, audio systems), user interface displays, external-facing USB ports (and their devices), speakers, externally daisy-chained high-voltage DC devices, and the like. Some of these elements may require a DC/DC regulator or a DC/AC inverter downstream (e.g., of a battery's 240 VDC) in order to operate. Some of these elements, such as the convection fans and oven lamps, may be enabled via manual control (e.g., a rocker switch), while others may be enabled via autonomous software control (e.g., via the control system 440).

The auxiliary electrical output 540 in various embodiments can comprise a standard electrical receptacle (e.g., 120 VAC receptacle) disposed on a housing of a load source 200 (e.g., a stove 125) that allows various other appliances, tools, or the like to be plugged into and powered by the load source system 300. In various embodiments, the electrical input 505 and/or battery 305 can directly or indirectly supply AC power to the auxiliary electrical output 540. For example, in various embodiments, electrical output 540 can be configured to be powered only by the electrical input 505; powered only by the battery 305; and/or powered by both the electrical input 505 and the battery 305 at the same time. As discussed herein, such powering capabilities can be desirable in various examples to allow for auxiliary power from the battery 305 while power from the electrical input 505 is unavailable or undesirable such as when there is a power outage or when power obtained from the electrical input 505 is undesirably expensive (e.g., when such power obtained from a power grid is expensive). Such powering capabilities can be desirable in various examples to allow for a combination of power from the electrical input 505 and battery 305 to be used, which can allow for greater power to the auxiliary electrical output 540 than would be available from the electrical input 505 alone, which can allow the auxiliary electrical output 540 to perform near, at, or above the capability of a stove 125 powered by 240 VAC, even though the load source system 300 is externally powered by only 120 VAC via the electrical input 505. Such powering capabilities can be desirable in various examples to allow for a combination of power from the electrical input 505 and battery 305 to be used, which can allow for a reduced amount of power consumed from the electrical input 505, which may be desirable when power obtained from the electrical input 505 is unstable, inconsistent, or undesirably expensive (e.g., when such power obtained from a power grid is expensive) or when it is desirable to draw less power from the electrical input 505 (e.g., where a circuit does not support drawing full power because of other appliances on the circuit). Such powering capabilities can be desirable in various examples to allow for the auxiliary electrical output 540 to be powered via the electrical input 505, when it is undesirable to use power from the battery 305, when the battery 305 is out of power, when the battery 305 is malfunctioning, when the battery 305 is overheating, when power from the electrical input 505 is obtained from a renewable source (e.g., solar), or the like. In some embodiments, the electrical input 505 (e.g., 120 VAC from a wall receptable) provides power to a dedicated, external-facing ‘auxiliary power’ inverter, which can function as a default passthrough for preserving the battery state of charge and avoiding power conversion losses (and the associated noise from fans).

One or more auxiliary electrical output 540 may be integrated into the load source system 300 in a convenient accessible location such as on the front of a stove 125 near the floor, behind a cover on the top of the stove 125, in a reachable location on the back of the stove 125, affixed with a small whip to allow the user to move the outlet to the kitchen counter near to the stove 125, on the top of the stove 125 with a fluids cover, and/or in any suitable location.

The auxiliary electrical output 540 may comprise a NEMA 5-15 or NEMA 5-20 plug in some examples. The auxiliary power port 540 in some examples may provide standardized AC power (e.g., 120 VAC power). DC auxiliary power ports in some alternative form (e.g., a USB port) may additionally or alternatively be included. The auxiliary electrical output 540 can be powered by in some embodiments by a DC battery and may connect to an internal inverter to convert the power from DC to AC.

An auxiliary power port 540 in some embodiments can be ‘full power’ or provide the max available power of 2400 w (nema 5-20) or 1800 w (nema 5-15), or the like. An auxiliary electrical output 540 in some examples can alternatively or dynamically provide less power, such as 1000 w, 500 w or 300 w, or the like.

The auxiliary electrical output 540 in some embodiments may be integrated into the load source system 300 as a passthrough system whereby a device could be plugged in to the auxiliary electrical output 540 and the power may by default be supplied via the AC power input, but then during a power outage or during other suitable situations, the load source system 300 can switch over to providing power via the battery 305.

The load source system 300 in some embodiments can additionally or alternatively include a DC auxiliary electrical output 540. This may provide a DC power rail in some examples. The DC auxiliary electrical output 540 may be used in various ways including to power an additional induction burner in some examples. Such an additional induction burner could be modular and could be placed on a nearby countertop to provide more stovetop capacity while cooking a larger meal. In another variation, a DC auxiliary electrical output 540 may be used to power an external inverter which could be used to provide AC power to a high-power device like an air fryer, a dishwasher, and the like. In some variations, a DC auxiliary electrical output 540 may be used to connect an external battery, which could be used as additional power storage capacity.

Additionally, or alternatively, one or more additional or alternative power inputs may be used as a power source, which may be AC and/or DC. For example, in some embodiments the electrical input 505 can be DC power. In some embodiments, there can be one or more additional DC power inputs in addition to an AC electrical input 505.

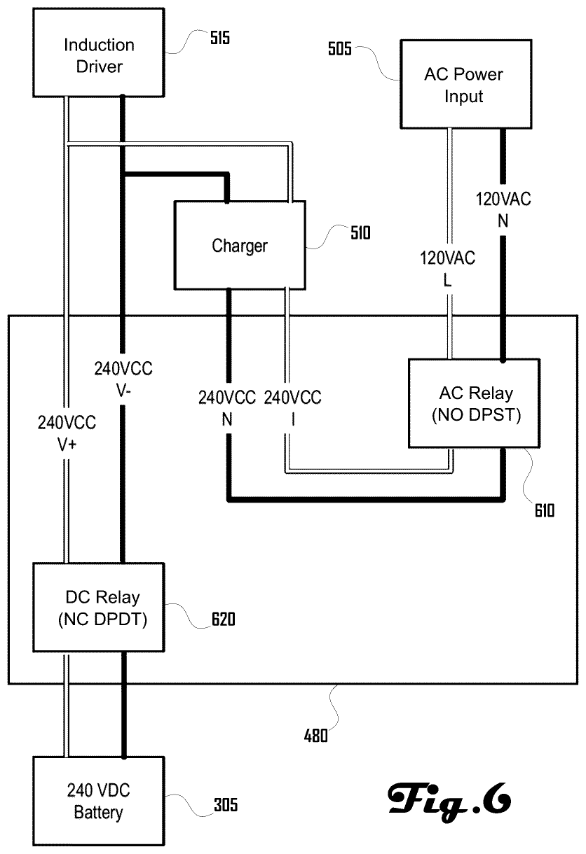

In various embodiments, an AC/DC conversion module 480 (see, e.g., FIG. 4) functions to transform AC power input from electrical input 505 and output DC power to charge the battery 305, induction driver 515, or the like. For example, as shown in the embodiment of FIG. 6, an AC power input may enter an AC/DC conversion module 480 through an AC relay 610 (e.g., normally open (NO) and double-pole, single-throw (DPST)) prior to going to a charger 510. The charger 510 can output a DC signal (e.g., 230 VDC) that may connect to the induction driver 515 and/or to a battery 305 via a DC relay 620 (e.g., normally closed (NC) and double-pole, double-throw (DPDT)).

DC power (e.g., nominally 240 VDC) from the charger 510 may be provided to the battery 305 by way of a safety relay in various examples. Current from the battery 305 can be provided to various elements of the load source system 300 by way of a safety relay and can serve as a source for powering elements such as a processor and/or safety triggers of the load source system 300 by way of a DC/DC regulator.

The AC power input 505 may connect (e.g., with a cord and plug) to an electrical receptacle (e.g., common receptable with 120 VAC 15 A, 20 A, or the like or an appliance outlet with 230 VAC with 20 A, 30 A, 50 A, or the like) to provide outside power to the load source system 300. The AC/DC conversion module 480 can use the AC power input from the power input 505 to charge the battery 305 source, used to charge supplementary battery systems or directly power various systems or elements.

In some variations, the amount of current drawn from the power input 505 may be limited in some embodiments (e.g., through a configuration setting). For example, the limit may be set below 10 A, 15 A, 20 A, 30 A, 50 A, or the like. For example, in a retrofit kitchen, there may be insufficient circuit capacity to operate all appliances at once so a stove 125 having a load source system 300 can be configured to draw less power. For example, a toaster and a microwave might be on the same circuit as a stove 125 having a load source system 300 and the stove 125 can be configured to lower maximum charging rate to facilitate operation of all appliances on the circuit.

In some embodiments, a load source system 300 can include a monitoring system that monitors incoming AC voltage of a shared branch circuit. During times of high use, the voltage can sag, and the load source system 300 can automatically lower charging current of the load source system 300 to accommodate (e.g., to avoid tripping the circuit breaker). Because the sensing and/or control can be part of the load source system 300, techniques like synchronous source detection may be used in some examples to calibrate out differences in grid voltage and for other applications.

An AC/DC conversion module 480 of some embodiments may output a DC power output (e.g., nominally 240 VDC), which as described may be provided to a battery 305 by way of a safety relay in some examples. The charger 510 and/or the battery 305 may be provided to elements of the system load source system 300 by way of a safety relay and may serve in some examples as the main source for powering one or more processors and/or safety triggers by way of a DC/DC regulator.

In some embodiments, DC power may primarily be used to directly power the high-load elements of the load source system 300. In a stovetop embodiment, the load source system 300 can include an induction heating module, which can function to perform induction heating. The induction heating module may include induction coil drives and/or interface with an integrated induction stovetop module. In some cases, the load source system 300 may be configured to interface with an outside or existing heating element. Alternatively, the heating element may be directly integrated and/or customized with the load source system 300.

As discussed, the load source system 300 in various embodiments can include one or more supplementary battery systems, which may be used as a backup to the battery 305. In some variations, such a supplementary battery system may be or include a battery-equipped Uninterruptible Power Supply (UPS); for example, in the event of a grid blackout and/or dead or disabled battery 305, to maintain some level of continuous processor operation (e.g., to continue logging events), the battery-equipped UPS can keep the processor(s) powered.

In order to satisfy a suitable safety standard (e.g., meet UL standards), in some embodiments there may be a series of redundant controls that can independently (e.g., without software) disable/disengage some or all potentially hazardous aspects of the load source system 300; for example, power to the charger 510; the output of high-voltage batteries; some or all connections powered off high-voltage batteries, and the like. Such a control scheme may include thermal fuses, current fuses, insulation fault detectors, or some combination thereof, whereby one tripped fuse can disconnect the trigger signal to the normally controlled relays that control the pathways and/or subsystems. Temperature fuses in some examples may be configured to trip/trigger at determined temperature points and may be oriented inside or near an oven, stovetop, and high-voltage battery. Current fuses may be integrated inside the battery 305 (e.g., integral to a battery management system (BMS)). Additional safety measures may include Ground Fault Protection between the one or both terminals of a DC signal (e.g., 240 VDC) and the systems chassis (e.g., range chassis), and a Ground Fault Protection between an auxiliary AC power outlet 540 and the chassis of the range.

Some variations of a load source system 300 and/or a method implemented by a load source system 300 can be configured to boost preheating capabilities of an oven or other heating element, and the like. The load source system 300 may be configured to implement process of a method that includes using the battery 305 to provide high instantaneous power output. This may be used to enable a “boost” mode for use during preheating or in other situations. Some convection ovens can utilize a rear convection element (e.g., positioned around a fan) and a top element which can principally be used for broiling. A broiling element may be used to boost the power of the oven during preheating in some examples. This may be performed in some embodiments when no food is in the oven to avoid burning of the food. Because a battery enabled stove of various embodiments can output higher instantaneous power than a conventional wired stove, this boost mode can be made to be quite powerful. In one example, a time of 5 minutes could be sufficient to preheat to 400 degrees Fahrenheit during such a boost mode, which could, for example, be two to three times as fast as a conventional pre-heating cycle.

In some embodiments, instead of using a power inverter to create AC power for a conventional oven fan (e.g., driven by a shaded pole motor) and/or oven light, DC-driven versions of an oven fan and/or oven light may be used. In some such variations, the driving circuitry can rely on a DCDC converter, which may be smaller and cheaper. These DC fans and/or lights may use proportional control, which in the case of the fan, can be used to modulate airflow, limit noise, create more even oven temperatures without convection baking the food. In the case of the light, a light can create softer lighting conditions, or be used to communicate information to the user, such as whether the oven is preheated, or if the food is done cooking.

Some variations of the load source system 300 and/or a method implemented by the load source system 300 may be configured to reduce or eliminate undesirable audible and tactile artifacts associated with AC's low-frequency envelope imposed on the generated electromagnetic field. In some induction systems driven by an AC signal, the envelope of an AC signal (e.g., 60 Hz, 120 Hz) can drive the induction system which can be both felt (vibrations) and heard. The load source system 300 and/or method implemented by the load source system 300 can use the DC signal which has a flat envelope such that the electromagnetic effects causing audible or tactile vibrations can be eliminated or reduced.

The use of a DC input in some examples can reduce the size of components used in driving an induction heating system. In AC-driven induction systems, bulky ripple capacitors may be used which are both expensive and large. Ripple capacitors can also reduce the overall efficiency of the circuit and reduce the power factor. Some AC-driven systems can require a PFC circuit and/or EMI/RFI circuits, which may be eliminated or simplified in the system when powering from a line-isolated DC battery. The system's DC input to an induction system, avoiding the need for such components, may result in a more energy efficient load source system 300 in some embodiments.

In some variations, the load source system 300 may include cascaded DC and AC relays. The load source system 300 may include a single DC relay to control a plurality of AC relays in some examples. By using a DC relay to switch first, in some embodiments the AC relays can be switched in a dry state to minimize or reduce contact arcing issues that can be associated with AC relays. This may also help to prolong the life of the contacts and reduce maintenance costs. Additionally, a single DC relay can be used to control multiple AC relays, which can simplify the wiring and control systems, and reduce the overall cost of the load source system 300.

In some variations, a DC powered approach of the load source system 300 or method implemented by the load source system 300 may enable usage of Metal-Oxide-Semiconductor Field-Effect Transistors (MOSFETs) to switch power to high powered loads. For example, MOSFETs may be used to switch 230 VDC 20 A power to an oven bake/broil heating element in some embodiments. MOSFETs may have increased switching life over other switching elements that can be used in AC operated ovens. This may result in increased life, easier maintenance, and/or more accurate temperature control because of an ability to rapidly switch between power states. As one potential benefit, a system variation using FET control with faster cycling may provide more latitude to control when each of the oven elements is on, to coordinate the power draw of each in order to limit the total power draw of the stove 125.

In some variations, the load source system 300 may include a maximum power point tracker (MPPT) which may function to enable the load source system 300 to accept power generated locally by a solar panel, wind turbine, or other source of power generation. This solar powered solution may be more generally applied as part of a general energy storage equipped (ESE) appliance, which may be a range stove 125 as described herein but could be any suitable type of appliance. In some variations, the ESE could be a water heater or heat pump or other suitable load source 200 as described herein.

In one example, energy can be generated by a solar panel, and pass through the MPPT into the battery 305 of the ESE appliance. This energy in various embodiments can augment power received from a receptacle 165 to the ESE appliance and can limit the total amount of power drawn from a home's power distribution system 150 by the ESE appliance. In some variations, the load source system 300 may be configured to avoid “backfeeding” of the home's electrical system or the grid, which may mean this kind of installation can take place without permission of a utility in some examples, thereby leading to simplified installation.

In some variations, the load source system 300 can include an interface subsystem to facilitate interfacing with an induction driver 515 (see FIG. 5). Interfacing with an induction driver 515 may enable the load source system 300 to be used with existing induction drivers 515 provided by other outside load source system 300. An interface subsystem may be configured to enable a process that when performed causes creating a DC current measurement and feeding the DC current measurement to a driver and synthesizing 120 Hz signal (or other suitable frequency). This solution may be internationally deployable by adapting the frequency to any desirable frequency.

In order to make an existing, traditionally AC-powered induction driver 515 work off a DC voltage (e.g., power from the battery 305), the induction driver 515 can be augmented with a controller that provides synthesized AC signals to it that satisfy a variety of conditions it may need met in order to operate. For example, an induction driver 515 may regularly measure the amplitude and/or frequency of the input power signal to ensure that components of the induction driver 515 can properly operate or synchronize off this signal (e.g., to improve power factor by switching at the signal's zero-crossing) or that such a signal is being cleanly powered and will not propagate as radiated noise or that the signal is electrically safe to pass through. Because the induction driver 515 is being powered off DC in various embodiments, the variability of an AC signal may no longer be relevant. Thus, the operation of the induction driver 515 can become geographically agnostic and can be deployed anywhere without special SKUs.

In one variation, a load source system 300 and/or method implemented by the load source system 300 may include a slow preheat/capped burner power mode, which can function to preserve energy stored by the battery 305. A control system may be used to manage operations of the device to adjust for stored power availability, predicted power availability from an AC power input 505 or some other power source in coordination with predicted usage of the appliance (e.g., time of day, cooking habits, etc.). In some embodiments, a load source system 300 and/or method implemented by the load source system 300 may use time and/or usage-based charging profiles. Charging of the auxiliary power source and appliance heating capabilities may be adjusted to meet expected requirements. Some examples of such methods are disclosed in related U.S. patent application Ser. No. 17/692,714, filed Mar. 11, 2022, entitled “APPLIANCE LEVEL BATTERY-BASED ENERGY STORAGE,” which is incorporated herein by reference.

In another variation, a load source system 300 and/or method implemented by the load source system 300 may include detecting circuit breaker (for shared branch circuit) overdraw by measuring voltage sag from wall. In another variation, a load source system 300 and/or method implemented by the load source system 300 may use special heating modes. For example, a load source system 300 and/or method implemented by the load source system 300 may include anti-warping heating profiles for pans, which may function as a gentle mode to prevent distortions or deterioration of cookware.

In another variation, a load source system 300 and/or method implemented by the load source system 300 may operate to manage power storage of the battery 305 based on external data sources. In one such example, the load source system 300 may charge the battery 305 when emissions intensity is below a threshold, based on external data.

In another variation, a load source system 300 and/or method implemented by the load source system 300 may use alternative heating approach to mitigate heating of a battery 305. For example, a load source system 300 and/or method implemented by the load source system 300 may use an upper oven element to assist a convection element so that lower element is not needed or used less, which may mitigate heating of a battery 305 stored below the oven.

In another variation, a load source system 300 and/or method implemented by the load source system 300 may use various sensing approaches. A load source system 300 and/or method implemented by the load source system 300 may use multi-probe oven chamber sensing. This may involve sensing and detecting uniformity of heat, and if a large enough temperature difference is detected, the load source system 300 can run convection fan for air mixing. A load source system 300 and/or method implemented by the load source system 300 may additionally include detecting operation of an oven fan (e.g., detecting a broken oven fan) and/or controlling the fan for augmented cooking.

In some variations, the load source system 300 may integrate the battery 305 into the load source system 300 in particular locations for enhanced usability and functionality. The location of the battery 305 in residential ranges for an enhanced induction range system can be desirable to ensure the efficient and safe operation of a range. One first variation can be to place the battery below the oven, within a defined cavity (e.g., where a range warming drawer may be located). In some variations, the battery 305 may be physically integrated into a warming drawer. In some variations, a battery 305 may replace a warming drawer in the appliance, or simply be below the oven. This location in various embodiments can provide access to cool air (e.g., due to a natural thermocline of the room) on the floor. The air may be utilized either passively or through forced convection to cool the battery 305 without having to pipe the air around the stove.

Additionally, having the battery 305 as low as possible or as close to the ground as possible can provide mechanical stability, acting as a counterweight to prevent the stove from falling over when the oven door is open. The battery 305 can transfer the weight directly onto the ground through feet attached to the stove or through the feet of the stove, minimizing the amount of material required to transfer the weight to the ground. Alternatively, weights (e.g., cement blocks or other counterweights) may be mounted or installed at the base of the stove. Additionally or alternatively, the load source system 300 may be mounted or fixed in position using brackets and screws.

Another variation can be to place a flat battery pack behind the stove, utilizing the space behind the stove. This location can provide a compact design of the stove, can enhance the aesthetic appeal of the stove and may not interfere with the operation of the stove. Depending on the specific design and dimensions of the enhanced induction or electric stove system, other locations can also be suitable for placing the battery.

In some variations, the load source system 300 may include battery fixturing that may facilitate moving or accessing a battery 305. This may be useful to enable cleaning, maintenance, and the like. The battery 305 may include feet of a material with low resistance (e.g., Delrin, Teflon, etc.) to enable the battery 305 to slide without loading attachment points to the stove 125. In another variation, the battery 305 may be attached to the stove 125 but have rolling feet. The load source system 300 in some examples may include design features to facilitate installation and servicing accessibility. The battery 305 and/or associated components may use connectors and fixturing mechanisms for ease of connecting power plugs and accessing the components of the battery 305 and/or associated components.

The battery 305 may be a detachable unit in some examples, which may enable the battery 305 to be supplied separately. This may be useful to allow for changing of a battery 305 and installation of the battery 305 into a previously set up appliance, swapping of a battery 305, or the like.

The battery 305 in various embodiments may include safety features to ensure that the battery 305 is used when the battery 305 is properly installed and in a safe operating condition. A battery control system that may be part of an auxiliary power source system may measure and record the state of the battery 305 through one or more sensors, which may include but is not limited to accelerometers, switches, thermometers, and the like.

In some variations, the battery 305 may include a protective casing or layer, which can be a component encasing the battery 305 in a protective material to ensure protection from fire. This may be designed to provide the battery 305 with at least 60 minutes or at least 120 minutes of protection in a building fire, or the like. For example, gypsum or similar fire retardant or phase-change material may be used. The load source system 300 in some embodiments may include a battery cooling system which in some examples can be a special cooling fan that activates only when needed to cool battery/oven interface.

A load source system 300 and/or method implemented by the load source system 300 may include an integrated safety system for addressing possible electrical safety issues. In the case of a cooking range, possible issues that may be mitigated can include detection of an oven over-temperature event, detection of a battery over-temperature event, and detection of an electrical hazard (e.g., insulation fault, incorrect installation, damaged battery, DC isolation fault, AC hazard, and the like).

In some embodiments, a method of safety system activation can comprise a determination that there is an oven over-temperature event present, that a battery over-temperature event is present, or that an electrical hazard event is present (e.g., by a control system 480 based on data from one or more sensors 490). In response, a safety system (e.g., safety circuit) can cause a suitable response, which can include a battery cut-out, a charger cut-out, grounding, ground fault circuit interruption (CFCI), and the like. In various examples, an over-temperature event can be determined based at least in part on data or physical response from a temperature sensor indicating a temperature above a given threshold for an amount of time.

In some embodiments, a safety system may enable safe operation of a battery electric range, with the battery 305 in close proximity to the oven 360 and/or cooktop 370. In some examples, over-temperature of the battery 305 can cut off the oven 360, and over-temperature of the oven 360 can cut off the battery 305, to ensure both are operating safely. Similar methods can be applied to other appliances or elements of a range or stove 125.

In some embodiments, the same set of relays may be used to perform activation of a plurality of safety measures (e.g., not multiple independent pairs of relays), with such safety measures including one or more of responding to a determined oven over-temperature event, responding to a determined battery over-temperature event, and responding to a determined electrical hazard event.

In some examples, a string of over-temperature cut-offs can be associated with various heat sources generally or specifically such as the battery 305, oven 360, cooktop 370, heating zones 372, and the like. In some embodiments such a string may have redundant over-temperature cutoffs for some or all such heat source locations. In some embodiments, two or more independent strings can have just one over-temperature cut-off at some or all such heat source locations. Various suitable sensors can be used for sensing temperature and generating an over-temperature cut-off response including thermal fuses, thermostats, thermocouples, thermistors, PTC (Positive Temperature Coefficient) devices, RTDs (Resistance Temperature Detectors), bimetallic switches, IC temperature sensors, thermal cut-out switches, and the like.

Redundant relays in some embodiments can be configured to stop some or all heating of the load source system 300 by cutting off the battery 305 and/or by cutting off the charger 510, or the like. Such a cutoff can be configured to de-power the oven 360, cooktop 370, heating zones 372, or other elements, including heat sources and non-heat sources. In some embodiments, at least some non-heat sources can remain active after such a cutoff such as an interface 380, 460 screen 384, processor 410, control system 440, communication system 450, auxiliary electrical output 540, and the like.

In some embodiments, the same or different cut-off relays can be configured to respond to electrical hazards, such as electrical hazards posed by insulation, isolation faults of the battery system, and the like. In some embodiments, a sensor string can have additional sensors or relays as part of the sensor string, which can be configured to open when an electrical fault is detected, thus triggering power cut-off relays.

In some embodiments, relays that perform a battery cut-off can be disposed within a battery enclosure, and in some examples can be configured to perform a safety function of preventing the battery from energizing unless it is correctly installed into the product (e.g., in an embodiment where the battery is removable). For example, in some embodiments, a string of sensors cannot be completed without the battery 305 correctly installed into the load source system 300, such that with a battery 305 not installed or incorrectly installed (e.g., battery connections improperly or incompletely seated), cut-off relays disabling battery power cannot turn on unless the battery 305 is installed into the load source system 300.

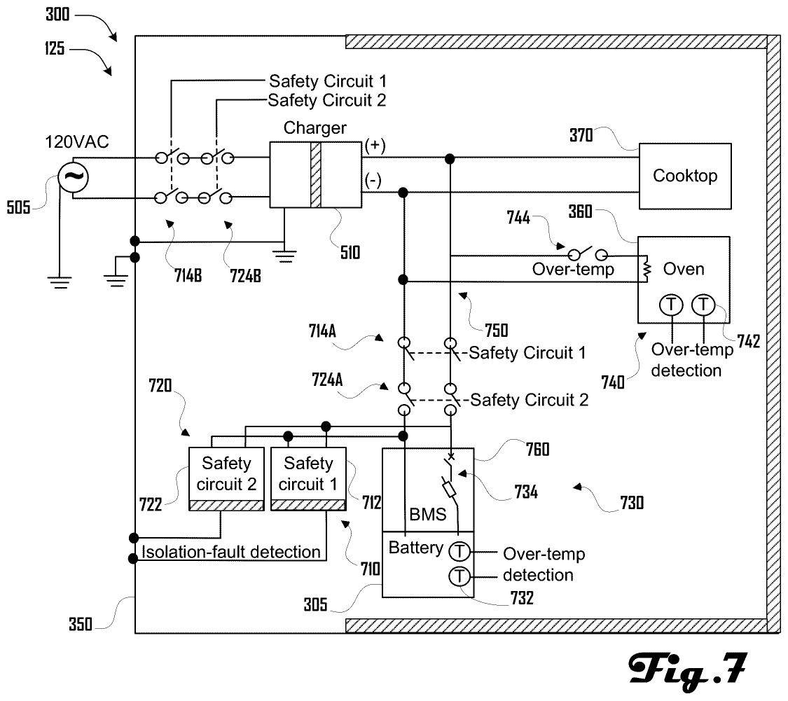

Turning to FIG. 7, an example embodiment of a load source system 300 of a stove 125 is illustrated, which comprises a plurality of safety systems 710, 720, 730, 740. The load source system 300 in this example comprises a first safety system 710 that comprises a first safety circuit 712 and two switch pairs 714A, 714B. The load source system 300 in this example further comprises a second safety system 720 that comprises a second safety circuit 722 and two switch pairs 724A, 724B.

In various embodiments, the first and second safety circuits 712, 722 can be connected to the housing 350 of the oven 125 and connected to a string 750 connected to the battery 305, a battery management system 750, an oven 360, a cooktop 370 and a charger 510. The first and second safety circuits 712, 722 can be configured to actuate switch pairs 714A, 724A disposed in parallel on the string 750. In various embodiments, actuating at least one of the switch pairs 714A, 724A on the string 750 can cause the battery 305 to be disconnected from the oven 360, cooktop 370 and charger 510, which can prevent or stop electrical power flowing to and/or from the battery 305 to and/or from the oven 360, cooktop 370 and charger 510. For example, actuating at least one of the switch pairs 714A, 724A on the string 750 can prevent or stop the charger 510 from charging the battery 350; prevent or stop the battery 305 from powering the oven 360; prevent or stop the battery 305 from powering the cooktop 370; and the like. Such a configuration can be desirable in various embodiments to cut power to heating elements such as the oven 360 and/or cooktop 370 in response to a determined or detected safety event by the first and/or second safety circuits 712, 722. Such a configuration can be desirable in various embodiments to cut power being provided to the battery 305 in response to a determined or detected safety event by the first and/or second safety circuits 712, 722.

The first and second safety circuits 712, 722 can be configured to respectively actuate the switch pairs 714B, 724B disposed between the AC electrical input 505 and charger 510. In various embodiments, actuating at least one of the switch pairs 714B, 724B between the AC electrical input 505 and charger 510 can cause the charger 510 to be disconnected from the AC electrical input 505, which can prevent or stop electrical power flowing to the charger 510 from the electrical input 505. For example, actuating at least one of the switch pairs 714B, 724B can prevent or stop the charger 510 from charging the battery 350; prevent or stop the charger 510 from powering the oven 360; prevent or stop the charger 510 from powering the cooktop 370; and the like. Such a configuration can be desirable in various embodiments to cut power to heating elements such as the oven 360 and/or cooktop 370 in response to a determined or detected safety event by the first and/or second safety circuits 712, 722. Such a configuration can be desirable in various embodiments to cut power being provided to the battery 305 in response to a determined or detected safety event by the first and/or second safety circuits 712, 722.

In various embodiments, the first and second safety circuits 712, 722 can respond to electrical hazards such as an insulation fault, an incorrect installation, damaged battery, DC isolation fault, AC hazard, and the like. In various embodiments, the first safety circuit 712 can be configured to simultaneously trip the switch pairs 714A, 714B, which can be configured to stop or prevent power to heating elements such as the oven 360 and/or cooktop 370 based on power from the battery 305 and/or the electrical input 505. Such a configuration can be desirable in various embodiments to cut power to heating elements such as the oven 360 and/or cooktop 370 in response to a determined or detected safety event by the first and/or second safety circuits 712, 722, regardless of whether the oven 360 and/or cooktop 370 are being powered by one or both of the battery 305 and power from the electrical input 505.

In various embodiments, the load source system 300 of the stove 125 can comprise a third safety system 730 associated with the battery 305, which can comprise at least one battery temperature sensor 732 associated with the battery 305, which can be configured to sense a temperature of the battery 305, which can be used to make a determination that the battery 305 is above a threshold temperature for a threshold amount of time. In response, the third safety system 730 can trigger a battery switch 734, which can prevent or cut power being provided to the battery 305 and/or prevent or cut power being provided by the battery 305. Such an embodiment can be desirable for identifying or determining presence of a battery over-temperature event and responding by generating a battery cut-out.

In various embodiments, the third safety system 730 can comprise any suitable number of battery temperature sensors 732 of any suitable type(s), which can be disposed, in, on or about the battery 305, including in some examples as part of a battery management system 760 associated with the battery 305. In various examples, the battery switch 734 can be part of a battery management system 760, or disposed in any other suitable location.

In various embodiments, the load source system 300 of the stove 125 can comprise a fourth safety system 740 associated with the oven 360, which can comprise at least one oven temperature sensor 742 associated with the oven 360, which can be configured to sense a temperature of the oven 360, which can be used to make a determination that the oven 360 is above a threshold temperature for a threshold amount of time. In response, the fourth safety system 740 can trigger an oven switch 744, which can prevent or cut power being provided to the oven 360. Such an embodiment can be desirable for identifying or determining presence of an oven over-temperature event and responding by generating an oven cut-out.

In various embodiments, the fourth safety system 740 can comprise any suitable number of oven temperature sensors 742 of any suitable type(s), which can be disposed, in, on or about the oven 360, including in some examples as part of an oven system associated with the oven 360. In various examples, the oven switch 744 can be disposed in any other suitable location.

In further embodiments, other elements of the stove 125 can have associated temperature safety systems, including heating elements such as the cooktop 370, one or more heating zones 372 of the cooktop 370, and the like. Such temperature safety systems can be desirable for identifying or determining presence of an over-temperature event for such elements.

In some embodiments, the same set of relays may be used to perform activation of a plurality of safety measures (e.g., not multiple independent pairs of relays), with such safety measures including one or more of responding to a determined oven over-temperature event, responding to a determined battery over-temperature event, and responding to a determined electrical hazard event.

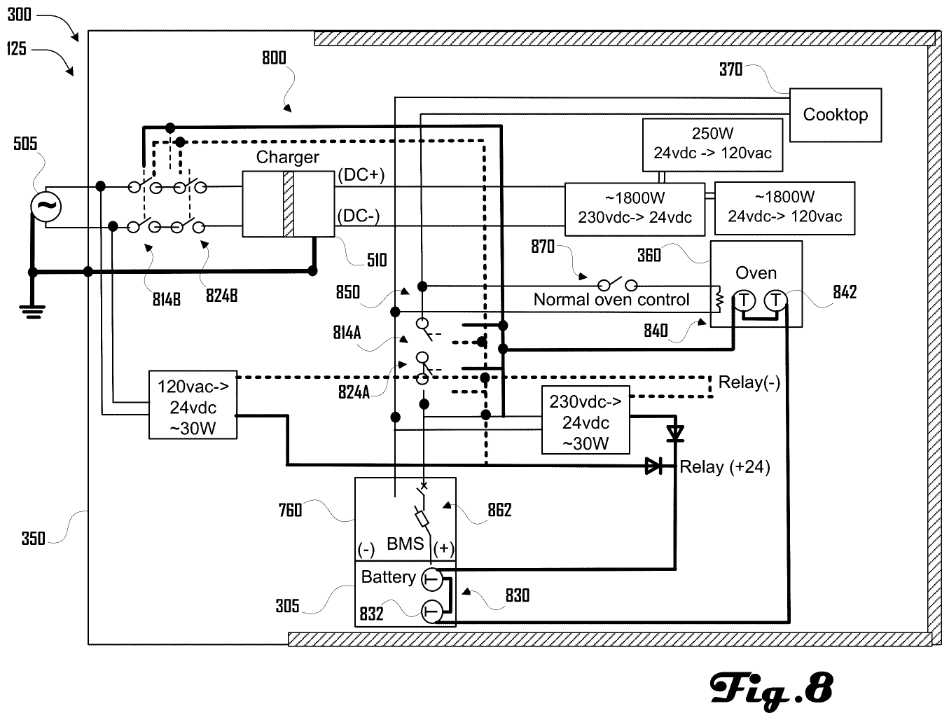

For example, FIG. 8 illustrates an example embodiment of a load source system 300 of a stove 125 comprising a relay system 800 configured for responding to a determined oven over-temperature event and responding to at least a determined battery over-temperature event. For example, the relay system 800 can extend between one or more respective temperature sensors 832, 842 of a battery safety system 830 and oven safety system 840. The relay system 800 can further extend between switches 814A, 814B, 824A, 824B. Accordingly, the relay system 800 can be configured for responding to both a determined oven over-temperature event and responding to at least a determined battery over-temperature event.

In some embodiments, the switches 814A, 824A can be part of 2× Single Pole Single Throw-Normally Open (SPST-NO) switch assembly disposed on a string 850 between the battery 305, oven 360, cooktop 370, and charger 510 that also includes a normal oven control switch 870 and normal battery switch 862 that can be part of a battery management system 760. In some embodiments, the switch pairs 814B, 824B can be part of a 2× Double Pole Single Throw-Normally Open (DPST-NO) switch assembly disposed between the electrical input 505 and the charger 510. In some embodiments, the switches 814A, 814B can be part of a first circuit and the switches 824A, 824B can be part of a second circuit. In some embodiments, the relay system 800 can be configured to respond to a determined electrical hazard event, or the like.

In various embodiments, a load source system 300 such as a stove 125 can be configured to operate in different operating modes depending on state of the battery 305. For example, a load source system 300 can be configured to operate a stove 125 in a full power mode or in one or more limited power mode (e.g., when the battery 305 is dead or when it is desirable to conserve power stored in the battery 305 and/or being drawn from a receptacle 165).

In various embodiments, a benefit of having a load source system 300 such as a stove 125 that comprises a battery 305 can be that the stove 125 can be operated even when the power from the grid and/or renewable sources is out, intermittent or limited. To facilitate uninterrupted use of a stove 125 under such condition, in some examples, an interface 460 can be configured to alert a user about the charge status of the battery 305 and/or the remaining energy left in the battery 305 so the user can make informed decisions on how much energy to use while cooking, such as delays in regaining power delivery from a utility or renewable sources; when the cost of energy from the grid is expensive; or the like.

A display or other presentation of energy consumption can be visualized in various suitable ways (e.g., to suit user preferences), such as an absolute percentage of battery capacity remaining, quantity of energy stored in kWh or Wh, an estimated time of exhaustion based on the current energy draw, an average of the last X number of minutes of cooking, and the like. In some embodiments, the load source system 300 can determine energy consumption using a machine learning approach based on a cooking training dataset (e.g., including data amassed over the life of the stove 125, a moving window of time therein, or the like).

In the case where the battery 305 is depleted, the user can be notified via the interface 460, such as via a display 384, another visual indicator, an audio indicator, or the like. The interface 460 in various examples can indicate that the stove 125 range will function at limited capacity based on the amount of energy coming from a receptacle 165 the stove 125 is connected to. In some embodiments, when limited power is available based on lack of power from the battery 305 or receptacle 165, the stove 125 can be configured to still have a functional oven 360, but in some examples, the stove 125 can take longer to reach temperature due to operating at lower than full power. In some embodiments, when limited power is available based on lack of power from the battery 305 or receptacle 165, the stove 125 can be configured to operate with a reduced number of burners and/or with less than max power output on one or more burners.

In various environments, a load source system 300 of a stove 125 can be configured to operate in any suitable number of power configurations, including one, two, three, four, five, ten, twelve, or the like. For example, some embodiments can include a full power operating configuration and a minimal operating power configuration, where the minimal operating power configuration provides less operating capacity than the full power operating configuration. Some embodiments can include a full power operating configuration, a first reduced operating power configuration that provides less operating capacity than the full power operating configuration, and a second reduced operating power configuration that provides less operating capacity than the first reduced operating power configuration and full power operating configuration.

Full and reduced or minimum operating power configurations of a stove 125 can provide more or less operating capacity in various suitable ways. For example, in embodiments where a stove 125 comprises an oven 360, a full power operating configuration can allow the oven 360 to operate at 100% power capacity, and one or more reduced operating power configurations can limit the oven 360 to operating at equal to or less than 80%, 75%, 70%, 65%, 60%, 55%, 50%, 45%, 40%, 35%, 30%, 25%, 20%, 15%, 10%, 5%, or the like, or a range between such example values. One embodiment can include a full power operating configuration that can allow the oven 360 to operate at 100% power capacity and a minimum operating power configuration that limits the oven 360 to operating at 50% power or less. Another embodiment can include a full power operating configuration can allow the oven 360 to operate at 100% power capacity, a first reduced operating power configuration that limits the oven 360 to operating at 65% power or less, and a second reduced operating power configuration that limits the oven 360 to operating at 35% power or less.

In embodiments where a stove 125 comprises a cooktop 370 with one or more heating regions 372 (e.g., separate induction burners), a full power operating configuration can allow the one or more heating regions 372 to operate at 100% power capacity, and one or more reduced operating power configurations can limit at least one of the one or more heating regions 372 to operating at equal to or less than 80%, 75%, 70%, 65%, 60%, 55%, 50%, 45%, 40%, 35%, 30%, 25%, 20%, 15%, 10%, 5%, or the like, or a range between such example values. One embodiment can include a full power operating configuration that can allow one or more heating regions 372 to operate at 100% power capacity and a minimum operating power configuration that limits the one or more heating regions 372 to operating at 50% power or less individually or collectively. Another embodiment can include a full power operating configuration that can allow the one or more heating regions 372 to operate at 100% power capacity, a first reduced operating power configuration that limits the one or more heating regions 372 to operating at 65% power or less individually or collectively, and a second reduced operating power configuration that limits the one or more heating regions 372 to operating at 35% power or less individually or collectively.

In some embodiments, where a stove comprises a cooktop 370 with a plurality of heating regions 372 (e.g., 2, 3, 4, 5 separate induction burners, or the like), different power configurations can limit the total number of heating regions 372 that are able to function at the same time. For example, where a cooktop 370 consists of four heating regions 372, a full power operating configuration can allow up to all four heating regions 372 to operate simultaneously and one or more reduced operating power configuration can limit the maximum heating regions 372 operating simultaneously to three, two or one at a time. In some examples, such a limitation can be on specific heating regions 372 or can apply to any sets of two, three or four heating regions 372 of the four heating regions 372.

In various embodiments, once power from a previously unavailable or unused source becomes available, the stove 125 can switch from a limited operation configuration to a fully operational configuration. For example, after operating in a limited operation configuration from only power from the receptacle 165, as a result of the battery 305 being depleted or below a minimum charge threshold, once the battery 305 has charged to a minimum change state (e.g., defined by a set charge percentage or historical data for how the stove 125 has been used), the stove 125 can return to a fully operational configuration based on power from the battery 305 and receptable 165. Such a configuration change can be presented via an interface 460 in various suitable ways.

In another example, after operating in a limited operation configuration from only power from the battery 305 as a result of the power from the receptacle 165 being unavailable or unused, the stove 125 can return to a fully operational configuration based on power from the battery 305 and receptable 165 once power from the receptacle 165 becomes available or usable (e.g., after a power outage; once the cost of power from the grid is below a cost threshold making it desirable to use; once renewable power becomes available via the receptacle 165 at a sufficient amount such as to provide full power instead of grid power; or the like).

In various embodiments, the load source system 300 can determine or predict a time to achieve different operational capabilities. For example, where a stove 125 is operating in a limited capability mode due to the battery 305 being depleted or having insufficient power, a determination or prediction can be made regarding how long it will take for the battery 305 to charge to a level where the stove 125 will be able to operate at a greater operational capacity and/or a full operational capacity. For example, where a minimum charge of 10% is required for the stove 125 to operate at full power, a determination can be made regarding the time it will take for the battery 305 to charge to 10% capacity. Such a determination can be made based on data such as current charging rate, current power use by the stove 125, predicted power use by the stove 125, current charging current, current charging voltage, stages of a charging protocol, and the like.

Similarly, in some embodiments, where a stove 125 is operating in a full operating configuration or a greater than minimum operating configuration, a determination or prediction can be made regarding how long the battery 305 has sufficient charge to operate at such a level and until the stove will switch to a minimum or lower operating configuration. For example, where a minimum charge of 10% is required for the stove 125 to operate at full power, a determination can be made regarding the time it will take for the battery 305 to be depleted to below or equal to 10% capacity. Such a determination can be made based on data such as current charging rate, current power use by the stove 125, predicted power use by the stove 125, current charging current, current charging voltage, stages of a charging protocol, and the like.

In some embodiments, an interface 460 of the load source system 300 can include a timer counting down to when the stove 125 is predicted to be able to operate at a full capacity configuration; is predicted to be able to operate at greater than a minimum capacity configuration; is predicted to be required to operate at a minimum operating configuration, is predicted to be required to operate at below a maximum operating configuration; and the like. In various examples, an ability of a load source system 300 to provide information about energy consumption, battery status, and switching between normal and one or more limited modes can enhance the user experience by empowering the user to make informed decisions about their usage of the enhanced induction stove system, thereby optimizing energy usage and user satisfaction. In various embodiments, a load source system 300 can automatically switch between one or more operational power modes without user interaction, such as when battery charge reaches or exceeds one or more threshold, when battery charge reaches or falls below one or more threshold, or the like. In some embodiments, operational power modes can be configured by a user, such as via an interface 460 of a load source system 300.

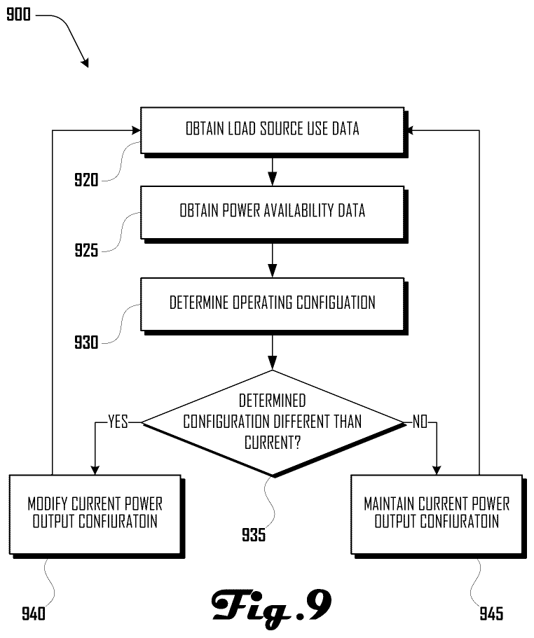

Turning to FIG. 9, an example method 900 of determining an operating configuration is illustrated, which includes block 920 where load source use data is obtained (e.g., stove use data), and block 925 where power availability data is obtained. At block 930, an operating configuration is determined, and at 935, a determination is made whether the determined operating configuration is different than a current operating configuration. If so, at 940, the current output configuration is modified (e.g., to the determined operating configuration). However, if not, the current operating configuration is maintained at 945. The method 900 returns to 920 regardless of whether a current operating configuration is changed or modified, which can allow for monitoring of whether a change in operating configuration is necessary, desirable, or the like. Such monitoring can be in real-time or periodically at various suitable intervals (e.g., real-time, a number of seconds, minutes, hours, days, or the like).

In various embodiments, load source use data can include data regarding elements of a load source 200 being used, such as an oven 360, one or more heating regions 372 of a cooktop 370, and the like. For example, use data can include the identity of one or more heating regions 372 of a cooktop 370 being used, a power level that a heating region 372 is set at, an amount of power being consumed by a heating region 372, a mode of a heating region 372, a power level that the oven 360 is set at, an amount of power being consumed by the oven 360, a mode of the oven 360, an amount of power being consumed by an auxiliary electrical output 540, a mode of an auxiliary electrical output 540, and the like.

In various embodiments, power availability data can include an indication of whether power is available from a battery 305, an amount of power available from a battery 305, voltage and/or current available from a battery 305, an indication of whether power is available from a receptacle 165, an amount of power available from a receptacle 165, voltage and/or current available from a receptacle 165, one or more source of power coming from the receptacle 165, cost of power coming from the receptacle 165, and the like.

In various embodiments, determining an operating configuration can be based at least in part on whether power is available from the battery 305 and/or receptacle 165. For example, where a determination is made that power from the receptacle 165 has become unavailable, but power from the battery 305 remains available, a determination can be made that an operating configuration should be changed to a reduced power configuration from a full power configuration. In another example, where a determination is made that power from the battery 305 has become unavailable, but power from the receptacle 165 remains available, a determination can be made that an operating configuration should be changed to a reduced power configuration from a full power configuration. In another example, where a determination is made that power from both the receptacle 165 and battery 305 are available after one being unavailable, then a determination can be made that an operating configuration should be changed from a reduced power configuration to a full power configuration.

In various embodiments, power from the battery 305 may be unavailable due to the battery 305 lacking charge, lacking charge above a threshold minimum amount, being broken, being absent from the load source system 300, being improperly installed in the load source system 300, where using power from the battery 305 is undesirable, or the like. In various embodiments, power from the receptacle 165 may unavailable due to a power outage of an electrical grid, lack power generated by a renewable source (e.g., solar, or wind), or where using power from the receptacle 165 is undesirable due to cost, being from a non-renewable source, or the like.

For example, in some embodiments, a determination can be made to change to a reduced power configuration from a full power configuration when the cost of power from an electrical grid obtained via the receptacle 165 is above a cost threshold, which may be based on price data, time of day, a selection by a user, or the like. In some embodiments, a determination can be made to change to a full power configuration from a reduced power configuration when the cost of power from an electrical grid obtained via the receptacle 165 is below a cost threshold, which may be based on price data, time of day, a selection by a user, or the like.

In some embodiments, a determination can be made to change to a reduced power configuration from a full power configuration when power from a renewable source becomes available, when power from a renewable source becomes available at an amount above a threshold, or the like. In some embodiments, a determination can be made to change to a full power configuration from a reduced power configuration when power from a renewable source becomes unavailable, when power from a renewable source becomes unavailable at an amount below a threshold, or the like.

In various embodiments, an operating configuration can be selected based on a mode of the load source system 300, which in some examples can be selected by a user, set based on a timer, set based on obtained data, and the like. In some embodiments, a mode can include a battery charging priority mode; a renewable energy mode that prioritizes use of renewable energy sources in powering the load source and/or charging the battery 305; a cost saving mode that prioritizes use of free energy sources such as renewable energy and/or when cost of power from the grid is more affordable; or a performance mode that prioritizes higher functionality of the load source 200 over battery charging, use of renewable energy, cost of power from the grid, or the like.

In some embodiments, a determination can be made to change to a reduced power configuration from a full power configuration when a user switches from a performance mode to a battery charging priority mode. In some embodiments, a determination can be made to change to a full power configuration from a reduced power configuration when a user switches from a battery charging priority mode to a performance mode.

In some embodiments, a determination can be made to change to a reduced power configuration from a full power configuration when a user switches from a performance mode to a cost saving or renewable energy priority mode. In some embodiments, a determination can be made to change to a full power configuration from a reduced power configuration when a user switched from a cost saving or renewable energy priority mode from a performance mode.

In some embodiments, a reduced power configuration can include limiting, stopping or preventing operation of one or more elements of a load source system 200, and for a stove 125 can include limiting, stopping or preventing operation of one or more of an oven 360, heating zones 372 of a cooktop 370, and an auxiliary electrical output 540.

In some embodiments, such a method 900 of FIG. 9 can be performed by one or more load source system 300, a user device, or battery server to configure one or more load source systems 300. For example, using FIG. 4 for purposes of illustration, in some embodiments, the load source system 300 can control its own configuration (e.g., via the method 900). In some embodiments, individual load source systems 300 can be as a group by another device or one of a set of load source systems 300 (e.g., a primary load source system 300). Accordingly, load source use data and power availability data can be obtained from a plurality of battery systems 300 or from a single battery system 300, which may or may not include communication of such data via a network (e.g., via communication system 450).

As discussed herein, determining an output configuration can be for various suitable purposes, such as to maximize use of renewable energy sources (e.g., solar panels 115); to maximize storage of power from renewable energy sources; to maximize storage of power from a power grid 110 when such power is at a low or lower cost; to maximize performance of a load source 200; to maximize energy efficiency of a load source; to maximize energy storage by one or more batteries 305; to minimize charging time for one or more batteries 305; and the like. For instance, a shorter nighttime cooking session can be completely covered in some examples by an on-board or associated battery 305, charged during the day with ample solar resources, while a longer, more demanding nighttime cooking session could be powered jointly by the battery 305 and low-capacity outlet (e.g., receptacle 165). In this way, the charge and discharge control laws of the system and/or network can maximize the use of renewable-generated electricity, in some examples, without impacting the experience of the user.

In various embodiments a load source system 300 can include settings that enable a user (e.g., via interface 460) to control functional and usability related aspects of the load source system 300, which in some examples can include a selection of a charging mode, such as based on user preferences, based on external factors, or the like. One embodiment can include a charging mode configured to charge the battery 305 via a receptacle 165 during off-peak hours for lower cost and less grid strain. For example, such a charging mode can be based on the time of day, day of the week, month, time of the year, or the like, which can be set by a user, based on historical patterns, or the like. In some examples, such a charging mode can be based on electricity pricing data (e.g., obtained from a utility company), with charging occurring when price drops below a threshold.

Another example charging mode can be configured to keep the battery 305 topped up all the time in preparation for utility power interruption or other desired use of the battery 305. Yet another example charging mode can be configured to charge the battery 305 during times when the electricity supplied to the receptacle 165 comes from a renewable resource such as solar or that at least prioritizes charging when renewable power is being supplied to the receptacle (e.g., only charging the battery 305 via renewable power unless the battery 305 reaches or is below a charge threshold). In various examples, such a charging mode can be based on data obtained regarding power sources, which can include a house server providing information on an amount of power being generated by one or more renewable sources and/or being provided by an electrical power grid.

To provide a user with information about such one or more charging modes, an interface 460 of the load source system 300 may display such charging modes on a digital display, along with a short description for each charging mode. In this way, the user can be informed about the options available to them and can choose the charging mode that best suits their needs or preferences.

In a home that has multiple appliances that have built-in batteries 305 that are networked together, one or more of the appliances may include an integrated control interface. An integrated control interface may be used, for example, to set global energy policies for the network of appliances such as charging after 9 pm or staying charged all the time in case of a blackout. In one example, it can be desirable to instruct a connected mini-split air conditioner to turn off from your stove because the stove is downstairs from the air conditioner, and you are already cooking on the stove. The ability to control appliances from other appliances can allow for embodiments of such appliances that do not have their own interface and rely on other nodes in the appliance network to control them.

In some embodiments, a stove 125 comprising a load source system 300 can include a temperature cruise control feature that allows users of the stove 125 to dynamically maintain a consistent temperature on one or more heating zones 372 of a cooktop 370. In some examples such a cruise control feature may enable a hybrid approach of mixing power-based control input for a heating zone 372 with temperature control input to the heating zone 372. Such a temperature cruise control feature in some examples can include a power level-based input mode that results in delivering a substantially consistent amount of continuous heat that is adjusted based on a power level (e.g., varying between low, medium-low, medium, medium-high, and high). This can emulate traditional gas stoves with an open loop heating situation where a user has to gauge the temperature and adjust the power level based on the conditions of what is in the pan. An interface 460 can include a mechanism to engage a temperature cruise control mode. When in a temperature cruise control mode, one or more sensors 490 (e.g., temperature sensors) may be used to maintain a substantially consistent temperature of the heated pan or cooking element. For example, in some embodiments, each heating zone 372 of a cooktop 370 can be associated with one or more sensor 490 (e.g., temperature sensor) configured to determine the temperature of a pot or pan at the heating zone 372, the temperature of the cooktop 370 at the heating zone 372, or the like.

In an embodiment, a method of maintaining temperature at a heating zone 372 can comprise obtaining an indication to enter a temperature-maintaining mode at a heating zone 372 of a cooktop 370, and in response, entering the temperature-maintaining mode at a heating zone 372 of a cooktop 370. The method can further include determining a temperature to maintain, which can be based on a user input, user setting, default setting, or the like. The method can further include obtaining temperature data associated from one or more sensors 490 associated with the heating zone 372 and determining whether the temperature is outside a range from the defined temperature to maintain (e.g., +/−0° C., 0.5° C., 1.0° C., 1.5° C., 2.0° C., 5.0° C., 10.0° C. 25.0° C., 50.0° C. or the like or a range between such example values). Where a determination is made that the temperature is within the range, a current power level of the heating zone 372 can be maintained; however, where a determination is made that the temperature is not within the range, power of the heating zone 372 can be increased or decreased to raise or lower the temperature to be within the temperature range. Such temperature sensing and power regulation can occur automatically at any suitable time interval while the temperature-maintaining mode is engaged. The method can further include receiving an indication to cease the temperature-maintaining mode at the heating zone 372 of the cooktop 370 and returning to a normal or default heating mode. In various embodiments, each of a plurality of heating zones 372 of a cooktop 370 can be configured to be set to different temperatures to maintain in accordance with separate temperature-maintaining modes of the separate heating zones 372.

In one variation, the knob 382 used to set power level may become the initiator for engaging and/or disengaging a temperature cruise control mode. For example, each burner control knob 382 may comprise a momentary push button that allows the user to turn on the “maintain temperature” mode once the user has identified a desired temperature for the given heating zone 372. In some examples, the user can be presented with and select a desired temperature setting (e.g., an interface 460 presents a temperature such as 200° C. that the user can select) or the user can select a temperature without an explicit temperature being indicated by an interface 460). In some variations, the knob 382 is not only a rotary element but also has a latching push button that enables the “maintain temperature” mode. Once this mode is enabled, the heating zones 372 can be configured to maintain the specified temperature without the need for the user to continuously check and adjust it. In one example, when the user identifies the ideal temperature based on tangible feedback such as cooking the perfect pancake, they can enable the “cruise control” mode to maintain that temperature consistently, similar to how a car maintains a speed. The “cruise control” mode may disable in some embodiments as soon as the user turns the knob 382 (or performs another suitable action), giving them control over the burner's temperature and power level. A temperature control cruise control feature of various embodiments can enhance the user experience by providing an intuitive interface for maintaining consistent burner temperatures, optimizing cooking quality and user satisfaction. Also, while the example of knobs 382 of an interface 380 are discussed as one example, initiating, controlling and terminating a cruise control mode can be done in various suitable ways such as with various suitable elements of an interface 460.

In various embodiments, an oven 360 of a stove 125 can comprise a cruise control mode. For example, the oven 360 of a stove 125 may include one or more temperature sensors and a digital temperature control loop that can enable the oven 360 to maintain a temperature within a desired range. In some embodiments, an oven 360 and/or heating zone 372 of a cooktop 370 can include a preheating mode that overshoots a set temperature point during pre-heating of the oven 360 and/or one or more heating zone 372. In some embodiments, a plurality of temperature sensors can provide better determination of the uniformity of temperature in the cavity of an oven 360. An average temperature can be determined based on data from a plurality of sensors 490 in some examples, and suitable operational adjustments can be applied based on that determined value. In some examples, where data from a plurality of temperature sensors identifies a difference in temperature above a threshold, the load source system 300 can enable a convection fan of the oven 360 to mix air in the cavity of the oven 360 to generate an increased temperature uniformity within the cavity of the oven 360.

For example, a method of heating an oven 360 can include obtaining data from a plurality of temperature sensors and determining whether a difference between one or more detected temperature is above a threshold difference, and if so, automatically turning on a fan of the oven 360. If a difference between one or more detected temperature is not above a threshold difference, then the fan can be automatically turned off or not turned on. Sampling of data from temperature sensors can occur at any suitable interval.

In some embodiments, a method of power allocation for a localized power grid that includes a battery supplemented appliance includes: in response to an appliance activation, providing power to the appliance, which may include providing battery power to the appliance; in response to external power usage, providing power to the external power usage, which may include providing battery power to the external power usage; and in response to battery depletion, providing power to the battery.

The method in various examples can provide dynamic power allocation for a local energy grid connected to a high-power consumption load source 200 such as a stove 125 comprising an energy storage device (e.g., a battery 305). The method may function with a load source system 300 as described herein but may additionally or alternatively be incorporated with any applicable system. Example use cases for such a method can include office buildings, local households, residential type buildings (e.g., apartment complexes, hotels), local communities (e.g., HOAs, condominium communities, gated communities, etc.), data farms, and/or any other type of local energy grid.

Providing power to the load source 200 can enable function of the load source 200 by providing power to the load source 200 once the load source 200 has been activated. In some embodiments, the load source 200 can comprise a high-power consumption stove 125 that may not be able to function powered directly by the local power grid (e.g., a 220V appliance, such as a stove 125, connected to a 110V receptacle 165). In some embodiments, the load source 200 can comprise a high-power consumption stove 125 that may not be able to fully function powered directly by the local power grid; for example, a 220V appliance, such as a stove 125, connected to a 110V receptacle 165 that is configured to fully function with 220V power; configured to fully function with greater than 110V power; configured to operate at a limited power configuration at 110V; configured to operate at a minimal power configuration at 110V; and the like.

In other words, some embodiments can include a load source 200 such as a stove 125 comprising a load source system 300 that is inoperable to operate in a full power configuration based on power from a receptacle 165 that the load source 200 is plugged into. In some embodiments, such a load source 200 may be inoperable to operate solely via power from the receptacle 165 that the load source 200 is plugged into and may require a combination of power from the receptacle 165 and a battery 305 of the load source system 300 to operate in a full power configuration (e.g., greater than 110V, at 220V, or the like). In some embodiments, such a load source 200 may be inoperable to operate in a full power configuration solely via power from the receptacle 165 that the load source 200 is plugged into and may require a combination of power from the receptacle 165 and a battery 305 of the load source system 300 to operate in a full power configuration (e.g., greater than 110V, at 220V, or the like), but may be able to operate in a reduced, low or minimal power configuration solely via power from the receptacle 165 that the load source 200 is plugged into. In some embodiments, the load source system 300 may be able to operate in a first reduced power configuration solely via power from the receptacle 165 that the load source 200 is plugged into; able to operate in a second reduced power configuration solely via power from the battery 305 of the load source 200; able to operate in a third reduced power configuration via a combination of power from the receptacle 165 that the load source 200 is plugged into and via power from the battery 305; and able to operate in a full power configuration via power from the receptacle 165 that the load source 200 is plugged into and from power from the battery 305. In various embodiments, the first, second and third reduced power configurations can have reduced operating capability of the load source 200 compared to the full power configuration. In various embodiments, the first and second reduced power configurations can have reduced operating capability of the load source 200 compared to the third power configuration.

In various examples, such embodiments can be desirable for providing operability of a load source 200 when power from the battery 305 is unavailable or undesirable to use; when power from the receptacle 165 is unavailable or undesirable to use; and/or when power from both the receptacle 165 and the battery 305 are available and desirable to use.

In various embodiments, providing power from the battery 305 to the load source 200 can function to provide supplementary power to the load source 200 in addition to or as an alternative to power from the receptacle 165, such that the load source 200 may operate in one or more power configuration. In some variations, not all load source 200 functionalities may require supplementary power, thus power from the battery 305 may be provided in some examples only when additional power is necessary for the load source 200 to function.

In some variations, a method may be implemented with a system that includes multiple battery integrated load sources 200. In some such variations, power may be provided to each load source 200 separately, wherein providing battery power to the load source 200 can function individually for each load source 200. For example, a battery 305 integrated with a single load source 200 may provide supplementary power for function of that single load source 200.

Providing power to the external power usage can function to provide electrical power to a device connected to the local power grid. Providing power to the external power usage in various examples can provide sufficient power to the device to enable the device to function within device specifications. Some examples can provide power to multiple devices, and in some household energy grid implementations, can function in allocating power to dozens of devices/operations as necessary or desired.

Providing power to the external power usage may include providing power from the battery 305 to the external power usage. Providing battery power to the external power usage may in some examples be dependent on the amount of external power usage and level of battery charge (e.g., current amount of power stored in the battery 305). Providing battery power to the external power usage may allow for supplementary power for the external power usage when more power is being used, and the battery 305 is sufficiently charged. Additionally, where the battery 305 is incorporated with the load source 200, providing battery power to the external power usage in some examples can be reserved for times when the load source 200 is not activated, and the battery 305 is not providing (e.g., supplementary) power to the load source 200. Thus, providing battery power to the external power usage can function in various examples to provide supplementary power for general power usage on the local grid during times of increased power need and/or when the load source 200 has reduced or no power need.

In some variations that include multiple batteries 305 integrated with multiple load sources 200, each battery 305 may have a separate call for providing battery power to the external power usage, wherein each non-activated load source 200 may have its integrated battery 305 provide power for external power usage, while each activated load source 200 may have its integrated battery 305 provide power for use of each activated load source 200.

Providing power to the battery 305 can function to charge the battery 305 from external power. Although providing power to the battery 305 may occur in various examples any time the battery 305 needs to be charged, in some examples charging the battery 305 can be initiated in times of low power consumption of the local power grid, (e.g., during times that the load source 200 is not in use and there is less than normal external power usage). For example, for a household power grid this may occur during the night.

In some embodiments, a load source 200 can comprise a stove 125 with a load source system 300 that operates on a standard 120V, 20-amp receptable 165, while still providing the functionality and quality of cooking experience available in a stove 125 that operates plugged into a standard 240V, 20-amp, 30-amp or 50-amp receptacle 165. Various embodiments can comprise a stove 125 with a load source system 300 that does not require electrical upgrades (e.g., installing a new 220V receptacle in place of a 110V receptacle) or skilled labor beyond that needed to perform a standard stove replacement, allowing the stove 125 to be installed in occupied apartments with limited resident disruption.

Various embodiments can include a stove 125 with a minimum of three cooking zones 372, at least two of which use induction coils; an electrically heated oven 360; be configured to plug into and operate from a standard three-prong household wall socket (e.g., 120 VAC+/−10%, single phase, 60 Hz socket on a 20-amp circuit breaker); be configured for installation that does not require an electrician or other skilled labor and can be completed by property management staff within two hours; have a width of 24″ or 30″, and a form factor that matches a standard slide-in range; that will achieve relevant UL certifications and meet all other applicable, industry standard safety requirements; be a cost-effective electrification retrofit option for multifamily residential buildings; and the like.

In various embodiments, a load source 200 (e.g., a stove 125) can be configured to pass one or more of the following standards: ASTM F1496: Standard Test Method for Performance of Convection Ovens; ASTM F1521: Standard Test Methods for Performance of Range Tops; UL 858: Standard for Household Electric Ranges; UL 2595: Standard for Safety for General requirements for battery-powered appliances; UL 1642: Standard for Lithium Batteries (Cells); UL 2054: Standard for Household and Commercial Batteries; UL/IEC 62133-2: Standard for Safety for Secondary Cells and Batteries containing Alkaline or Other Non-Acid Electrolytes—Safety Requirements for Portable Sealed Secondary Cells & for Batteries Made From Them for Use in Portable Application; UL 1973: Standard for Batteries for Use in Stationary, Vehicle Auxiliary Power and Light Electric Rail (LER) Applications; UL 9540 A: Standard for Test Method for Evaluating Thermal Runaway Fire Propagation in Battery Energy Storage Systems; and the like.

Various embodiments can include a load source 200 (e.g., a stove 125) having one or more of the following characteristics: maximum power of the load source 200 running off an electrical panel that does not exceed 1,800 W; maximum Amps used by the load source 200 while in use that does not exceed 16 A; a minimum of three cooking zones 372, with at least two of which comprising induction coils; one induction coil that is at least 8 inches in diameter and placed at the front of the range to facilitate its preferential use; a glass cooktop 370; being without exposed resistance coils for the cooking zones 372; the ability to combine two or more cooking zones into a larger single zone; have a water heat-up time on the cooking zones 372 of the cooktop 370 that is no more than 7 minutes (e.g., following ASTM F1521 Standard Test Methods for Performance of Range Tops); cooking zones 372 having a turndown ratio of at least 6:1 in at least 10 increments from lowest to highest heat (e.g., via knobs 382 of an interface 380); controls of a cooktop 370 and/or oven 360 that include a clock, timer, oven temperature display and oven/broiler presets (e.g., via an interface 380); controls of an interface 380 that are Americans with Disabilities Act (ADA) compliant; have a set of controls (e.g., knobs 382) that are no higher than 48 inches above the ground and placed at the front of the stove 125 such that a user does not need to reach past or over a cooking zone 372 to control the cooking zone 372; an oven 360 with minimum volume of 2.5 cu ft for 24″ width or 4.5 cu ft for 30″ width; an oven 360 with a minimum of three rack positions; an oven 360 with a broiler; an oven 360 with a convection fan; an oven 360 with an oven light; an oven 360 with performance that meets or exceeds ASTM F1496; an oven 360 and/or broiler capable of operating at full power simultaneously with the largest heating zone 372 of the cooktop 370 at full power for at least 10 minutes; a battery 305 integrated into the stove 125 such that the battery 305 cannot be removed by a user, but that can be swapped out by a trained technician with the proper tools; a battery 305 with a minimum of 5,000 charge cycles; and ability to operate two or more heating zones 372 of a cooktop at full power simultaneously with an oven 360 at full power for a minimum of ten minutes.

It should be clear that the embodiments discussed herein are only some example embodiments of a load source system 300 and that load source systems 300 having fewer or more elements or having more or less complexity are within the scope and spirit of the present disclosure. For example, one or more of the elements of FIG. 3-8 can be specifically absent in some embodiments, can be present in any suitable plurality, or the like. In some embodiments, a communication system 450 can be absent and the load source system 300 can be inoperable for wired and/or wireless communication with other devices. In some embodiments, elements such as processor 410 and clock 430 can be absent. The interface 460 can comprise a plurality of interface elements or a complex interface in some examples or can be a simple interface 460 in some embodiments or can be absent. In some embodiments, an interface for the load source system 300 can be embodied on a separate device such as a user device (e.g., a smart phone, laptop, home automation system, or other suitable device). Additionally, battery systems 300 can be various suitable sizes, including systems that weigh 1-5 pounds, 10-30 pounds, 50-100 pounds, 150-500 pounds, 500-1,500 pounds, or the like.

Additionally, in some embodiments, on-board or network control laws can be adaptive to patterns of use, which can allow a given battery capacity to adapt to expected demands. Further, these laws in various embodiments can be configured to adapt to local time-of-use rates, allowing behind-the-scenes energy arbitrage. Implementation of these control laws can be based on reinforcement learning and controls techniques, accompanied by best practice user interfaces allowing homeowner monitoring and tuning.

Various embodiments can be configured for managing the thermal requirements of the battery 305 of the load source 200. Due to the high-energy density, thermal runaway of lithium batteries can be a safety concern and should be prevented in various examples. Additionally, on a less catastrophic level, operating batteries at elevated temperatures can impact lifetime of the battery. Because of these factors, a battery management system 760 can have integrated temperature sensing and thermal interlocking. Accordingly, various embodiments can comprise a battery management system 760 along with careful thermal design to isolate battery compartments from regions of the appliance or local environment with unsafe operating temperatures. For instance, an effective design strategy for thermal management in various embodiments is building high aspect ratio packs adjacent to the ambient environment. Another strategy can be to incorporate fire suppression at the appliance level in the individual load source system 300. For example, in some embodiments a load source system 300 can include a fire suppression system that comprises sensors operable to determine whether a fire is occurring in the battery, and if so, execute fire-suppression measures such as releasing foam, liquid, gas, generating a vacuum, or the like to extinguish the fire.

Some embodiments can be configured for obtaining adequate safety certifications by placing batteries directly into appliances and obtaining sufficient buy-in from appliance manufacturers to adopt this technology. Mitigation strategies may include one or more of the following. First, some embodiments can include data analytics and software modeling to estimate the most effective appliance targets and quantify value propositions. For instance, some examples can include localized estimates of the value per watt-hour capacity for each appliance based on time-of-use electricity prices, grid scale and distributed renewables enabled, and avoided electrical upgrade costs. Second, some embodiments can include hardware units which can sit between an existing appliance and the electrical outlet, before integrating with appliances. These hardware units can verify the value proposition in terms of achievable demand response under real-world use, as well as test robustness of the hardware, networking, and control electronics and can be used in place of appliances with integrated batteries, along with appliances with integrated batteries, with conventional appliances before replacement with a battery-integrated appliance, and the like. Third, various embodiments can include safety certifications through UL or another body, as well as green certifications through the nascent ENERGY STAR Connected Functionality program or similar.

In various embodiments (see, e.g., FIG. 3), the battery can reside within the appliance itself, whether a stove, refrigerator, HVAC system, clothes washer, clothes dryer, TV, game machines, tools, BBQ, lighting, lawnmower, grass blower, vacuum cleaner, blender, juicer, food processor, basement freezer, speakers, audio equipment, cooling fans, or other appliances. These batteries, in some examples, may be factory installed and integrated directly with the control electronics of the appliance.

In various embodiments, control schemes of such appliances may operate in several modes including one or more of the following examples. First, such appliances may effectively share loads between a wall plug and a battery based on estimated usage requirements without impeding user experience. This scheme may be used in some examples to maximize the energy used from a solar installation or other alternative energy source, or to enable the use of high-capacity devices running from a 110V socket or enable the use of time-of-use electricity rates. Another control scheme may operate when the appliance is not in use, nor expected to be in use in the near future, where the appliance provides energy arbitrage services, which can enable a house to absorb and store cheap electricity from the grid for later use.

In various embodiments, control schemes for battery integrated appliances may function using several levels of data including one or more of the following examples. First, they may rely only on calendar and time of day to predict loads and supply. Second, they may incorporate historical use data to tailor the algorithms to the habits of the user. Third, they may report data back to a central system where it is aggregated and used to provide control laws. Fourth, it may accept user input to switch control modes (for instance, a user can press a button to prepare the stove to cook a large meal, during which it will pre-charge to full capacity and/or load share between the battery and plug during operation). Fifth, they may use data about electricity rates (e.g., time-of-use rates) from the utility to tailor control laws to use the cheapest electricity from the grid. Sixth, they may use data from a rooftop solar array to predict and maximize the use of available solar electricity.

Additional benefits may be provided to the appliances by the batteries in accordance with further embodiments. For example, many conventional appliances have performance limited by the peak power provided by the wall outlet. The batteries can allow for much higher peak powers, which can be used to increase the performance of appliances. For instance, induction stoves can have extremely fast temperature ramp up, higher peak outputs, and lower noise. On-demand water heating can have higher capacity, enabling storage-free water heaters with higher outputs. Electric kettles can be made to boil faster. For devices with motors, these motors can be run with higher peak powers, and if desired, at voltages more optimal than the AC from the wall. In some cases, the battery thermal management can be synergistic with the appliance performance. For instance, the heat from the battery pack can boost the coefficient of performance of heat pump devices like electric dryers.

With a home electric system, many costs can be proportional to peak power. Installing batteries at end uses can decrease peak power, and hence decrease these costs. By enabling hybrid AC/DC systems, battery-integrated appliances may also enable the use of higher efficiency solid state power conversion, including inverters and DC/DC voltage conversion.

Battery-integrated appliances of various embodiments can provide fire retardant capabilities, to protect against thermal runaway of lithium batteries, and can include a fire alarm to warn of an emergency. Device health monitoring may also be incorporated to monitor the state of health of the battery pack. This can be implemented through capacity monitoring, internal resistance measurements, or impedance spectroscopy. Such devices may also be made waterproof to protect batteries and electronics. These devices can also provide voltage regulation services for the house electrical system.

In various embodiments, a battery can allow high-power appliances to be usable with 120V receptacles as opposed to having to install a 240V power source. In some examples, batteries can have 4-24 hours of storage. Some embodiments can obtain real-time or historical use data for a room, house, building, block, city, state, and the like. In various examples, it can be beneficial to minimize inversions (e.g., inverter in battery module that sits on DC bus can prevent multiple inversions). Some embodiments can have power sharing between appliances (e.g., via extension cords, existing or new in-wall wiring, Ethernet, and the like). Some examples can have a battery module that is integral or replaceable within the appliance. Such a battery module can be configured to be a self-contained unit that is waterproof, heatproof, and the like, and can provide for shallow cycling of battery, fire suppression, battery monitoring, and the like. The whole module, including control systems, may be a replaceable unit since control systems may be inexpensive compared to the battery.

The battery module in various examples can obtain and use different types of data to control battery use. This can depend on network connectivity or complexity of the system. A simple battery module can simply include a clock and lookup table with the battery module operating based on time, day, season, or the like. Another more complex version can store use history from only the battery module itself or local battery modules and use a clock to control battery operation. Another more complex version can have network connectivity (e.g., to the Internet), which can provide access to data from an electrical grid, use data from remote modules, etc.

Various embodiments can be configured to forecast use based on data discussed above, or the like. Some embodiments can be configured to operate based on user input (e.g., user indicates he is about to or will cook a meal at a later time or date). Forecasting can be based on data such as user calendars, user defined schedules, or the like.

Some devices can have large ramp-up requirements and having a local battery 305 can reduce this, resulting in faster, better appliances (e.g., faster heating). Appliances can be configured to dial up voltages as necessary to provide for improved appliances. Other benefits can include electrostatics in washer/dryer, quieter operation from supersonic induction, increased efficiency of inverters, and the like.

While specific examples are discussed herein, these examples should not be construed to be limiting on the wide variety of alternative and additional embodiments that are within the scope and spirit of the present disclosure. For example, appliances, devices or systems can be associated with one or more batteries as discussed herein. Also, while residential examples are the focus of some examples herein, further embodiments can include multi-family buildings, commercial buildings, vehicles, or the like.

As used herein, first, second, third, etc., are used to characterize and distinguish various elements, components, regions, layers and/or sections. These elements, components, regions, layers and/or sections should not be limited by these terms. Use of numerical terms may be used to distinguish one element, component, region, layer and/or section from another element, component, region, layer and/or section. Use of such numerical terms does not imply a sequence or order unless clearly indicated by the context. Such numerical references may be used interchangeable without departing from the teaching of the embodiments and variations herein.

The described embodiments are susceptible to various modifications and alternative forms, and specific examples thereof have been shown by way of example in the drawings and are herein described in detail. It should be understood, however, that the described embodiments are not to be limited to the particular forms or methods disclosed, but to the contrary, the present disclosure is to cover all modifications, equivalents, and alternatives. Additionally, elements of a given embodiment should not be construed to be applicable to only that example embodiment and therefore elements of one example embodiment can be applicable to other embodiments. Additionally, elements that are specifically shown in example embodiments should be construed to cover embodiments that comprise, consist essentially of, or consist of such elements, or such elements can be explicitly absent from further embodiments. Accordingly, the recitation of an element being present in one example should be construed to support some embodiments where such an element is explicitly absent.

1. A computer implemented method of determining an operating configuration of an electric stove, the method comprising:
obtaining stove use data associated with the electric stove, the electric stove comprising:
a cooktop having a plurality of heating regions that each include an inductive heating coil;
an interface comprising a plurality of knobs and a display, wherein at least a portion of the plurality of knobs are respectively configured to control the plurality of heating regions;
a power cord connected to a 120V receptacle;
a charger that obtains power from the 120V receptacle;
a housing;
a rechargeable 230 VDC-250 VDC lithium-based battery integrally disposed within the housing, the battery configured to receive power from and be charged by the charger;
an induction driver that drives the inductive heating coils of the heating regions of the cooktop including in a first configuration with only power from the battery, a second configuration with only power from the 120V receptacle and a third configuration with power from both the battery and the 120V receptacle;
an electric oven configured to be powered in the first configuration with only power from the battery, the second configuration with only power from the 120V receptacle and the third configuration with power from both the battery and the 120V receptacle; and
an auxiliary electrical output configured to output 120V power in the first configuration with only power from the battery, the second configuration with only power from the 120V receptacle and the third configuration with power from both the battery and the 120V receptacle,
wherein the obtained stove use data comprises:
information regarding current use of at least one of the heating regions of the cooktop,
information regarding current use of the electric oven, and
information regarding use of the auxiliary electrical output,
obtaining power availability data that includes information regarding power availability from the 120V receptacle via the power cord and information regarding power availability from the battery;
determining an operating configuration based at least in part on the obtained stove use data and the obtained power availability data, the determined operating configuration including one of:
a full power configuration where the heating regions and the oven operate at a maximum power greater than 120V input voltage based on power from both the 120V receptacle and the battery or power solely from the battery, and
a reduced power configuration where the heating regions and the oven operate at a reduced power less than the maximum power, based on power solely from the 120V receptacle or power solely from the battery, and
switching to the determined operating configuration including one of: switching from the full power configuration to the reduced power configuration or switching from the reduced power configuration to the full power configuration.

2. The computer implemented method of claim 1, wherein the full power configuration further comprises the auxiliary electrical output outputting 120V power and wherein the reduced power configuration includes ceased electrical power output from the auxiliary electrical output.

3. The computer implemented method of claim 1, wherein the full power configuration comprises the heating regions and oven operating at 240V input voltage based on power from both the 120V receptacle and the battery or power solely from the battery.

4. The computer implemented method of claim 1, wherein determining the operating configuration is further based at least in part on the obtained power availability data that indicates that power has become unavailable from the 120V receptacle or that power has become unavailable from the battery.

5. A computer implemented method of determining an operating configuration of a stove, the method comprising:
obtaining stove use data associated with the stove, the stove comprising:
a cooktop having a plurality of heating regions;
a power cord connected to a 120V receptacle;
a charger that obtains power from the 120V receptacle;
a housing;
a rechargeable 230 VDC-250 VDC battery integrally disposed within the housing, the battery configured to receive power from and be charged by the charger;
a driver that drives the heating regions of the cooktop in a plurality of configurations, including two or more of: a first configuration with only power from the battery, a second configuration with only power from the 120V receptacle and a third configuration with power from both the battery and the 120V receptacle;
an oven configured to be powered in a plurality of configurations, including two or more of: the first configuration with only power from the battery, the second configuration with only power from the 120V receptacle and the third configuration with power from both the battery and the 120V receptacle; and
wherein the obtained stove use data comprises:
information regarding use of at least one of the heating regions of the cooktop, and
information regarding use of the oven,
obtaining power availability data that includes information regarding power availability from the 120V receptacle via the power cord and information regarding power availability from the battery;
determining an operating configuration based at least in part on the obtained stove use data and the obtained power availability data, the determined operating configuration including one of:
a full power configuration where the heating regions and the oven operate at a maximum power greater than 120V input voltage based on power from both the 120V receptacle and the battery or power solely from the battery, and
a reduced power configuration where the heating regions and the oven operate at a reduced power less than the maximum power, based on power solely from the 120V receptacle or power solely from the battery, and
switching to the determined operating configuration including one of: switching from the full power configuration to the reduced power configuration or switching from the reduced power configuration to the full power configuration.

6. The computer implemented method of claim 5, wherein the stove further comprises an auxiliary electrical output configured to output 120V power in two or more of: the first configuration with only power from the battery, the second configuration with only power from the 120V receptacle and the third configuration with power from both the battery and the 120V receptacle.

7. The computer implemented method of claim 5, wherein the battery is lithium-based, including at least one of: lithium-ion (Li-ion), LiFePO₄ (Lithium Iron Phosphate) and lithium-ion polymer (LiPo).

8. The computer implemented method of claim 5, wherein the stove further comprises an interface comprising a plurality of knobs and a display, wherein at least a portion of the plurality of knobs are respectively configured to control the plurality of heating regions.

9. The computer implemented method of claim 5, wherein the plurality of heating regions each include an inductive heating coil.

10. The computer implemented method of claim 5, wherein the full power configuration comprises the heating regions and oven operating at greater than 200V input voltage based on power from both the 120V receptacle and the battery or power solely from the battery.

11. A computer implemented method of determining an operating configuration of a stove, the method comprising:
obtaining stove use data associated with the stove, the stove comprising:
a cooktop having a plurality of heating regions;
a power cord connected to a receptacle;
a housing;
a battery disposed within the housing,
wherein the obtained stove use data comprises:
information regarding use of at least one of the heating regions of the cooktop,
obtaining power availability data that includes information regarding power availability from the receptacle via the power cord and information regarding power availability from the battery;
determining an operating configuration based at least in part on the obtained stove use data and the obtained power availability data, the determined operating configuration including one of:
a full power configuration where the heating regions operate at a maximum power greater than 120V input voltage based on power from both the receptacle and the battery or power solely from the battery, and
a reduced power configuration where the heating regions operate at a reduced power less than the maximum power, based on power solely from the receptacle or power solely from the battery, and
switching to the determined operating configuration including one of: switching from the full power configuration to the reduced power configuration or switching from the reduced power configuration to the full power configuration.

12. The computer implemented method of claim 11, wherein the stove further comprises a charger that obtains power from the receptacle; and wherein the battery is configured to receive power from and be charged by the charger.

13. The computer implemented method of claim 11, wherein the battery is rechargeable, 230 VDC-250 VDC, and integrally disposed within the housing.

14. The computer implemented method of claim 11, wherein the stove further comprises a driver that drives the heating regions of the cooktop in two or more configurations, including two or more of: a first configuration with only power from the battery, a second configuration with only power from the receptacle and a third configuration with power from both the battery and the receptacle.

15. The computer implemented method of claim 11, wherein the stove further comprises an oven configured to be powered in two or more configurations, including two or more of a first configuration with only power from the battery, a second configuration with only power from the receptacle and a third configuration with power from both the battery and the receptacle.

16. The computer implemented method of claim 11, wherein the stove further comprises an oven configured to operate in a plurality of configurations, including:
a full power configuration where the heating regions and the oven operate at a maximum power greater than 120V input voltage based on power from both the receptacle and the battery or power solely from the battery, and
a reduced power configuration where the heating regions and the oven operate at a reduced power less than the maximum power, based on power solely from the receptacle or power solely from the battery.

17. The computer implemented method of claim 11, wherein the full power configuration comprises the heating regions operating at 240V input voltage based on power from both the receptacle and the battery or power solely from the battery.

18. The computer implemented method of claim 11, wherein determining the operating configuration is further based at least in part on the obtained power availability data that indicates that power has become unavailable from the receptacle or that power has become unavailable from the battery.

19. The computer implemented method of claim 11, wherein one or more of the plurality of heating regions each include an inductive heating coil.

20. The computer implemented method of claim 11, wherein the stove further comprises an auxiliary electrical output configured to output power in a plurality of configurations, including in two of more of: a first configuration with only power from the battery, a second configuration with only power from the receptacle and a third configuration with power from both the battery and the receptacle.
